(19) United States
(12) Patent Application Publication
(10) Pub. No.: US 2009/0119706 A1
(43) Pub. Date: May 7, 2009

(54) Generation and Delivery of Stepped-Frame Content Via MPEG Transport Streams

(75) Inventors: David Hope, Laguna Beach, CA (US); Brenton C. Hahn, North Hollywood, CA (US); Chandra Kotaru, Redondo Beach, CA (US)

Correspondence Address: FOLEY & LARDNER LLP, P.O. BOX 80278, SAN DIEGO, CA, 92138-0278, US

(73) Assignee: Stepframe Media, Inc.

(21) Appl. No.: 12/237,128

(22) Filed: Sep. 24, 2008

Related U.S. Application Data
(63) Continuation-in-part of application No. 11/677,692, filed on Feb. 22, 2007.
Application No. 11/677,692 is a continuation-in-part of application No. 11/636,271, filed on Dec. 8, 2006.
(60) Provisional application No. 60/751,170, filed on Dec. 16, 2005.

(51) Int. Cl. H04N 7/173; H04N 5/445

(52) U.S. Cl. 725/38; 725/114; 725/133

(57) ABSTRACT

Systems and methods are disclosed for processing a video data streams having an input adapted for receiving and processing the video signal and rendering an output signal in a digital format, detecting a particular code within an individual frame of the processed signal that identifies the type of frame that contains the code, and storing the identified frame in a retrievable memory location of the system. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

The present application is a Continuation-In-Part of U.S. patent application Ser. No. 11/677,692 filed Feb. 11, 2007, which is a Continuation-In-Part of U.S. patent application Ser. No. 11/636,271 filed Dec. 8, 2006, which claims the benefit of the filing date of U.S. Provisional Application No. 60/751,170, filed Dec. 16, 2005.

### TECHNICAL FIELD

The present invention generally relates to systems and methods of video and similar content production, delivery, recording, and viewing and, more specifically, to systems and methods of video and similar content production, delivery, recording, and viewing where such content is primarily intended to be viewed using stepped-frame content.

### BACKGROUND

Television programming and television commercial advertisements have traditionally been produced with the intent of the viewer watching the content in real time or quasi-live mode. If, for example, a commercial is nominally 30 seconds long, the producers and broadcasters of the commercial have always intended that it take 30 seconds for the commercial to be broadcast, and that the viewer take 30 seconds to view the commercial. Similarly, if a television program is 30 minutes long, including commercials, then the producers and broadcasters of the program have always intended that the viewer watch this in real time, and thus take 30 minutes to do so.

With the introduction of home videotape recorders it became possible for a home television viewer or other viewer to record, or videotape, a television program and/or commercial for later playback. Typically such devices also allow the viewer to “fast-forward” through any part of the program, and thus not watch that part of the program. Typically, viewers would use this feature to fast-forward through the commercials that had been broadcast within the program, in order to watch the program without such commercial interruptions. However, as only a small percentage of viewers actually recorded a particular program on videotape recorders for later viewing, and as fast-forwarding through the commercials using videotape technology is not particularly accurate or user friendly, the percentage of viewers that actually use this technique is not believed to be particularly high. Nevertheless, advertisers miss the opportunity to reach these viewers.

More recently, new technologies have been introduced that are gradually replacing the videotape machine as the means of recording television programs and commercials in the home and elsewhere. In addition, due to the many benefits offered by these new devices, it is believed that they will continue to gain in market penetration, and may ultimately replace the home videotape recorder in many more homes, and elsewhere. One such leading technology is the Personal Digital Video Recorder (PDVR) that utilizes new digital technologies to allow a viewer to record significant amounts of television programming and commercials easily, and store them on a hard drive. One of the leading technologies in this area currently is that provided by TiVo®. PDVR's are also commonly referred to as PVR's, DVR's, TiVo's and the like.

In addition to allowing a viewer to more easily record significant amounts of television programming, some offering the ability to record many hours of programming and commercials, many of these devices also incorporate other features that are an improvement over earlier videotape technologies. One of these features, typically, allows a viewer to more easily fast-forward through, or “skip” the commercials that were initially broadcast within the program. Another feature typically allows a viewer to stepped-frame through any or all of the recorded content, and view each individual frame for as long as they wish. The result of the various improvements incorporated in these new technologies used for recording television programs and commercials is that a much higher proportion of viewers who have access to these technologies are expected to record a much higher percentage of the programs they ultimately watch. In addition, a much higher percentage of these viewers are also expected to use these technologies to fast-forward through or skip watching the commercials.

At present, advertising in general, and the traditional 30-second television commercial in particular, support the vast majority of the television industry in the USA and beyond. Advertisers, often through their advertising agencies or media buying companies, spend billions of dollars per year in the USA with television networks, cable companies and others, to buy time within television programming in order to air their commercials. Typically these advertisers pay for these time slots, or advertising spots, based upon the number of viewers and/or type of viewers (by demographic breakdown or otherwise) that they believe will ultimately see their commercial. In addition, they buy time in particular television programs that they believe already attract the kind of viewer that they are trying to reach.

As such, as more and more viewers gain access to these new technologies, and as more and more of them use these technologies to skip through the commercials, advertisers are likely going to want to pay less and less for the time slots within these programs. This is likely to lead to a number of fundamental problems for advertisers, advertising agencies, television networks, cable channels, television producers and others who deliver advertising-supported programming. For example, advertisers recognize the fact that advertising on television is one of their most important means of advertising their products and services, etc. However, if more and more viewers use new technologies to avoid watching the commercials, then over time advertisers will find traditional television commercials to be less and less effective. Similarly, if fewer people are watching the commercials, advertising agencies may likely find that their clients, the advertisers, will spend less money hiring them to create and to buy time to air these commercials.

Meanwhile, television networks, cable channels and other current and future media delivery systems will likely receive less and less money to air traditional commercials. This in turn will significantly reduce these networks' revenues and profitability. Similarly, these networks, cable television channels and other delivery systems will therefore have less and less money to pay for television programs from producers and production companies, who will also thus see their revenues and profits threatened.

These various segments of the television industry currently recognize these potential threats to their industry posed by these new technologies. In view of this, many companies within each of these segments are already looking for ways in which to ensure that advertisers continue to have access to television viewers and that viewers continue to see advertising messages on television. For example, many companies are now using different techniques, such as “product placement”, to incorporate advertising messages within the actual body of a television program rather than within a traditional commercial that is aired within a program. The logic behind this new strategy is that, although viewers can easily fast-forward past a traditional commercial without missing any part of the actual program, they cannot easily fast-forward though a product that is actually used within the program itself.

Another technique being tried by the industry to solve this problem is “Sponsored Programming” whereby an advertiser contributes to the production cost of a program in return for the producers of that program incorporating advertising messages and/or product placements subtly within the program. However, many if not all of these techniques are limited in scope, as it is often difficult to use product placement and similar techniques to communicate the many aspects of a company's products or services that can currently be communicated via a traditional commercial. For example, although an advertiser may be able to communicate to a viewer the new styling of a new model car by placing the car in a television drama series where it is driven by one of the characters in the series, it is more difficult to explain “dealer discounts” or promote upcoming “sales”. Similarly, it is also often difficult to incorporate a wide range of advertising messages within a sponsored program, whose main objective is to provide the viewer with an entertaining television program and not to bombard them with advertising messages. Indeed, many viewers, and more recently some television industry groups, do not like this trend of incorporating myriad advertising messages within a program, and there is thus both viewer and industry pressure to reduce and/or eliminate these techniques.

Another way in which advertisers and their agencies are attempting to get viewers to continue to view their commercials is by producing commercials that are more entertaining in their own right, in the hope that viewers will want to watch the commercials and will thus not be tempted to fast-forward through them. However, although some commercials may have become more entertaining in recent years, research still appears to show that most viewers with access to these new technologies still elect to avoid the commercials altogether.

In yet another technique being tried to ensure that viewers still see advertising messages, many television networks and cable companies are placing commercial messages over the top of a television program while it is being broadcast. Often these messages are superimposed at the bottom, or in one or more corners of the screen. For example, often these messages are used by such channels to advertise future programs that will appear on the channel, or to show the channel's logo, etc. However, many viewers find these advertising messages distract them from the program they are trying to watch and, as such, these messages often tend to alienate many viewers. Also, as these messages are being shown while a viewer is primarily trying to watch the actual program, there is some question as to the effectiveness of this type of advertising. Consequently, it is clear that advertisers, advertising agencies, and the television industry at large are actively looking for new ways to use television to get viewers to watch a wide range of advertising messages, and thus to prevent these new technologies from destroying their ability to do this. However, it is also clear that none of the current methods being tried effectively offer advertisers, their agencies, or the various television companies a satisfactory range of options to do this.

Another aspect of the current television industry that it is important to understand when considering the benefits of the current invention is the infomercial industry. Infomercials are typically long form commercials, often of 30 minutes or one hour in length. These commercial programs are usually produced to look like an informative television program, but typically promote a particular product that the program producers are trying to sell to viewers. As with typical programs and commercials, these infomercials are designed for real time viewing. Infomercial producers tend to purchase 30 minute or one hour blocks of time from television networks or cable channels in which to air these long form commercials. Typically these channels have blocks of time available, often late at night and during the early hours of the morning, where there are not enough viewers tuning in to the channel to justify airing actual programs. By selling this time to infomercial producers these channels can then make additional revenues from these time slots.

The infomercial industry is also likely to be adversely affected by these new technologies. As more and more viewers are able to watch programs they have recorded on their PDVR's whenever they wish, there are likely to be fewer and fewer viewers who will be tuning in to a particular channel late at night to watch the programming being broadcast in real time by these channels. Thus these viewers will not be tuning in at the times that typical infomercials are being aired. Also, it is unlikely that infomercials will be the type of program that many viewers will record for future viewing, as they tend to be more of an impulse view. However, the fact that such channels are willing to sell large blocks of time to advertisers, and that these time slots may be of less value to infomercial producers in the future, provides another potential use and advantage of the current invention as will be explained. Three other ways by which advertisers get their advertising and marketing messages across to their potential clients are through the use of printed catalogues, brochures, and other print advertising.

Generally catalogues tend to be produced by manufacturers and retailers, and often consist of glossy photographs, drawings, and brief descriptions of a whole range of different products offered for sale by such retailers. Manufacturers and retailers in a whole range of industries produce such catalogues. For example catalogues are produced by clothing retailers such as “GAP™”, and “L.L. BEAN™”, Christmas gift retailers, gardening supply companies, home electronics retailers, and the like. Catalogues also often include the prices of each product, as well as a detailed description of how a potential customer can order the products available in the catalogues and have them delivered to their homes. Catalogues are often mailed directly to the homes of potential customers, or are available from the retail stores of the companies who produce them.

In contrast, brochures are generally produced by both manufacturers and retailers, and often consist of a range of glossy photographs, drawings, key facts, and very detailed descriptions of the products being offered for sale. For example a car manufacturer such as BMW™ may produce a brochure about a specific car, or a specific range of cars. Often brochures are only available directly from the manufacturer on request, or may be available at key locations where potential buyers can pick up a copy. For example a buyer interested in buying a new BMW™ may be able to pick up a brochure or series of brochures on the latest models from the local BMW™ dealership.

Print advertising is a term that not only incorporates catalogues and brochures, but also covers advertising placed in newspapers, magazines, and other printed matter. Advertisers use such print advertising to advertise new products, new features of old products, enhance product brand names, offer discount coupons, advertise “Sales” and so on. Over the years, types of print advertising have developed that cross over these various categories, so that these descriptions should be not be considered exclusive or exhaustive.

Print advertising, especially catalogues and brochures, has a number of advantages over television commercial advertising, while television commercial advertising has a number of advantages over print advertising. As such, many advertisers use a combination of television advertising and print advertising when advertising and marketing their products and services. For example, advertisers can often use print advertising to highlight more products, or more features, facts, figures, and photographs of products than can typically be shown in a 30-second commercial. Also, print advertising can more easily be used to offer discount coupons, notify buyers of local sales, and the like. In addition, and particularly relevant to the current invention, it is well known that potential customers will retain copies of certain types of print advertising, especially catalogues and brochures, for a period of time, and will go back and read them at their convenience, time and time again.

However, print advertising also has a number of weaknesses when compared to television commercial advertising. Most importantly, even those catalogues with the glossiest photographs cannot match the visual and audio impact of a 30-second commercial. In addition, some catalogues and brochures can be very expensive both to produce, and to deliver to potential customers. A catalogue or brochure must be produced, printed, and often mailed to each individual prospective customer. Often many brochures and catalogues, as well as other print ads, are sent to customers who have absolutely no interest in them and who typically throw them in the trash. As such, there is often a lot of waste involved in this method of production and delivery, not only the actual cost of manufacture and shipping, but the wasted time and effort, and also the huge waste of natural resources such as all the paper that is thrown away.

Also, these catalogues and brochures often take up a lot of room in a potential customer's home or office, and may be discarded for this fact alone. Also, customers who save a whole range of catalogues and brochures may have difficulty locating the one they want at the time they want, or may forget which catalogue contains the specific product they are interested in. Also, if a catalogue is not mailed to a specific potential customer, or if a potential customer is unable to visit a place where a catalogue or brochure is available (such as the BMW™ dealership), then such a potential customer may never see such a catalogue or brochure, leading to a missed sales opportunity. Furthermore, both catalogue and TV advertising tend to be limited in the number of distinct images they present of a given product. This may also lead to lost sales. For example, a potential customer may be reluctant to order, say, a couch on the basis of a quick glimpse of it in a TV ad or a single picture in a catalogue. However, while a furniture catalogue showing full-page front, back, side and top views of every item would be much more informative, and more likely to lead to sales, it would likely be prohibitively expensive to produce and mail using current techniques. Similarly, it is believed that many companies who would like to use catalogues and brochures as part of their business strategy currently find the cost of doing so using current techniques prohibitively expensive.

As can be seen, there is a need for an improved method and system for producing and delivering advertising and sponsorship messages to a television audience. Furthermore, there is a need for a method of producing and delivering advertising and sponsorship messages to a television audience that will encourage viewers to record and watch the advertising and sponsorship messages instead of fast-forwarding through them when using new technologies such as PDVR's. Still further, there is a need for a method of producing and delivering content that is intended to be watched one frame at a time in “stepped-frame” mode. Still further, there is a need for a cheaper and easier method and system of delivering content such as catalogues, brochures, print advertising, and other types content normally printed and distributed on paper. Still further there is the need for a method and system of delivering such content via television broadcast or cable or via the Internet so that it can be recorded on a device such as a PDVR and played back at the viewer's leisure using “stepped-frame” mode. Still further there is a need for production, delivery and recording of content that may be viewed one frame at a time at the speed the viewer wants.

Still further, there is a need for a method and system for advertising that is effective and, therefore, will be widely used by advertising agencies and advertisers. Still further, there is a need for a method and system for advertising that encourages advertisers to buy television timeslots and that is preferred by advertisers over printed advertising. Still further, there is a need for a method and system for advertising that eliminates printing and distributing of printed advertisement materials. Still further, there is a need for a method and system for advertising that can deliver far more information and in much greater detail than typical prior art television commercials or printed advertising materials while utilizing existing, widely available, and widely used electronic equipment. Still further, there is a need for a method and system for advertising that enables the provided content to be easily recorded, stored, and accessed. There has still further arisen a need for a method and system for advertising that enables an individual to select desired content for easily and effectively recording, storing, and viewing with already existing electronic equipment.

### SUMMARY

In one aspect of the present invention, a method of production and delivery of content comprises the steps of: creating at least one individual frame from source material of step-frame/frame advance content; transmitting at least one individual frame; receiving and recording at least one individual frame; playing back the recorded at least one individual frame in stepped-frame mode; and viewing the content in stepped-frame mode.

In another aspect of the present invention, a method of production and delivery of searchable content comprises the steps of: creating an individual frame from source material of stepped-frame content; marking the individual frame for electronic identification; transmitting and receiving the individual frame at a standard frame rate; searching for the individual frame; identifying the individual frame; recording the individual frame; playing back the individual frame in stepped-frame mode; and viewing the content in stepped-frame mode.

In a further aspect of the present invention, a method for simultaneous production and delivery of real-time content and stepped-frame content includes the steps of: converting source material of real-time content into a first still image for real-time viewing, wherein the first still image occupies a first section of an individual frame; converting source material of stepped-frame content into a second still image for stepped-frame viewing, wherein the second still image occupies a second section of the same individual frame; creating at least one additional individual frame, possibly in the same manner, and putting the individual frames in sequence; transmitting the sequence of the individual frames at a standard frame rate; receiving and recording the sequence of the individual frames; playing back the recording of the sequence in real-time mode for viewing the real-time content in real time; and playing back the recording of the sequence in stepped-frame mode for viewing the stepped-frame content in stepped-frame mode.

In a still further aspect of the present invention, a method for production and delivery of content for sequential viewing includes the steps of: creating a first sequence of first individual frames containing real-time content; creating a second sequence of second individual frames containing stepped-frame content; editing the first sequence of the first individual frames together with the second sequence of the second individual frames creating a final sequence, wherein the first sequence and the second sequence are in succession; transmitting the final sequence at a standard frame rate; receiving and recording the final sequence; playing back the first sequence of first individual frames for viewing in real time; and playing back the second sequence of second individual frames for viewing in stepped-frame mode.

In a still further aspect of the present invention, an information system comprises: a production device that converts source material images of stepped-frame content into individual frames; a delivery medium that transmits the individual frames; a recording device that receives and records the individual frames, and wherein the recording device plays back the individual frames in stepped-frame mode; and a viewing device that displays the stepped-frame content in stepped-frame mode.

In yet another aspect of the present invention, a method or system for recording, separation, and retrieval of combined real-time and stepped-frame content comprises: tagging the stepped-frame frames using embedded coding that may include metadata information; transmitting the tagged frames together with standard real-time video content; receiving the combined video signal using a PDVR or similar type device; detecting and retrieving tagged and/or metadata content; and, depending on the tagged or metadata content information, removing or copying the tagged or metadata content frames to a location or locations separate from the real time content.

These and other features, aspects, and advantages of the present invention will become better understood with reference to the following drawings, descriptions and claims.

### BRIEF DESCRIPTION OF THE DRAWINGS

Features, aspects, and embodiments of the inventions are described in conjunction with the attached drawings, in which:

FIG. 1 illustrates a single-frame Master File used to generate Step-frame Video Content;

FIG. 2 illustrates a Cover Page File used to generate Step-frame Video Content;

FIGS. 3a-3e illustrate a series of Category Sub-Master Files used to generate Step-frame Video Content;

FIGS. 4a-4c illustrate individual pages created in a single category using a category Sub-Master File used to generate Step-frame Video Content;

FIGS. 5a-5c illustrate Step-frame Video Content in which the left half of the video screen appears to be a conventional real-time video TV commercial, while the right half of the screen is for Step-frame Video Content;

FIGS. 6a-6c illustrate real-time video confined to the top half of a screen, while the bottom half is left blank for Step-frame Video Content;

FIGS. 7a-7c illustrate photos cropped to the proportions of the blank areas in the previously created real-time video shown in FIG. 6;

FIGS. 8a-8c illustrate the insertion of still photos as Step-frame Video Content in the blank bottom sections of the individual frames of a real-time video;

FIG. 9 is a block diagram schematically representing a content production and delivery system, according to the present invention;

FIG. 10 is a flow diagram showing a first method according to the present invention;

FIG. 11 is a flow diagram showing a second method according to the present invention;

FIG. 12 is a flow diagram showing a third method according to the present invention;

FIG. 13 is a flow diagram showing a fourth method according to the present invention;

FIG. 14 is a flow diagram depicting the video data stream through the basic components according to the present invention;

FIG. 15 is a flow diagram depicting an exemplary scenario for PDVR detection of stepped-frame coded frames within a “South Park” video broadcast;

FIG. 16 is a flow diagram depicting an exemplary scenario for PC (or other computer device) detection of stepped-frame coded frames within a Web streaming video news clip;

FIG. 17 presents an algorithm that effects some exemplary stepped-frame detection and identification functions of the present invention;

FIG. 18 presents exemplary codes that can be embedded into video frames intended for viewing in stepped-frame mode;

FIG. 19 depicts an exemplary meta-information directory according to the present invention for recorded and archived stepped-frame data;

FIG. 20 depicts an exemplary user interface window providing selection choices to the user according to the present invention;

FIG. 21 presents an exemplary algorithm according to the present invention for interpreting codes embedded within video frames;

FIG. 22 depicts an exemplary user interface window providing choices of other code-linked stepped-frame frames, a Web link, and a telephone link;

FIG. 23 presents an exemplary algorithm according to the present invention for detecting a future referenced frame and pausing on that frame;

FIG. 24 illustrates an exemplary packetized elementary stream (PES) packet;

FIG. 25 illustrates an exemplary transport stream packet;

FIG. 26 illustrates an exemplary organization of program specific information (PSI);

FIG. 27 illustrates an exemplary program allocation table (PAT);

FIG. 28 illustrates a stepped-frame authoring tool in one embodiment;

FIG. 29 illustrates an exemplary data structure of a SMIL file in one embodiment;

FIG. 30 illustrates the operation of an MPEG conversion tool in one embodiment;

FIG. 31 illustrates the organization of stepped-frame images within an MPEG frame in one embodiment;

FIG. 32 illustrates the operation of a stepped-frame content splicing tool in one embodiment;

FIG. 33 illustrates the timing of a splicing operation in one embodiment;

FIG. 34 illustrates the operation of a set top box (STB) plug-in in one embodiment;

FIG. 35 illustrates the operation of a stepped-frame content (SFC) renderer in one embodiment;

FIG. 36 illustrates an SFC rendering application in one embodiment;

FIG. 37 illustrates a rendered screen layout in one embodiment;

FIG. 38 illustrates an exemplary stepped-frame content library folder organization in one embodiment;

FIG. 39 is a flowchart illustrating a method in one embodiment; and

FIG. 40 is a flowchart illustrating a method in another embodiment.

### DETAILED DESCRIPTION

The type of content contemplated for stepped-frame viewing includes but is not limited to advertising content, entertainment content, informational content, educational content and the like. Such content may be produced as video or other means that allows such content to be transmitted and received by viewing devices, including but not limited to video monitors, television sets, computers, cell phones, personal digital media players, PDA's, gaming devices and the like. Delivery includes but is not limited to delivery by various means, including but not limited to television broadcast, cable distribution, internet distribution or access such as video streaming, and wireless distribution, to television sets, computers, cell phones, PDA's, gaming devices and the like. Recording includes recording of such content so delivered on a recording device such as a videotape recorder, digital video disc recorder, personal digital media player, Personal Digital Video Recorder (“PDVR”), computer hard drive, or similar means. To “step-frame” means that a viewer plays back the content from the recording device and moves forward and/or backward through the content and views a series of single frames one frame at a time, perhaps using a device such as a remote control that controls such viewing device, and spends as much time as they like looking at each individual frame.

A video production, such as a television program or commercial, like a motion picture, is actually a rapid sequence of individual frames of still images. In the case of the American NTSC television standard, there are approximately 30 of these frames per second (fps). Thus, it is possible to use television to deliver, for example, approximately 900 individual frames or pictures to a standard NTSC television set during the course of a 30-second commercial. Similarly, it is also possible to deliver approximately 108,000 individual frames of picture during the course of an hour. All calculations made in this application are based on this 30 fps NTSC standard for convenience and ease of explanation. While in many other countries, the standard television frame rate is different, the calculations that apply to these other frame rates would be readily apparent to persons skilled in the field of the invention. Also, certain types of video transmission, such as online video streaming, often are streamed at alternative standard rates, due to compression and other issues. In such instances standard frames per second shall include those commonly used in the industry to transmit all forms of moving images. Furthermore, a viewer can use either certain traditional videotape recorders, or new technologies such as PDVR's, digital video disc recorders, and personal digital media players, to record video or similar content, initiate and then pause the video playback, view individual video frames, and stepped-frame through sequences of still video images one frame at a time

Additionally, another key feature of many of these new technologies, such as PDVR's and digital video disc recorders, and one that is pertinent to this invention, is that many of these devices include technology that more easily allows a viewer to both record content such as a program or commercial, and view individual frames of such content they have thus recorded in stepped-frame mode, spending as much time as they like viewing each individual frame. In addition, as these new technologies evolve to allow the delivery of content such as video content to other devices such as cell phones, personal digital media players, computers, gaming devices, and the like, the manufacturers of these devices are also likely to include similar features to allow for the recording and playback of content in stepped-frame mode. The following are descriptions of two exemplary processes for creating and assembling stepped-frame video content.

“Stepped-frame video content” is defined as any video content that is created or assembled with the intent that the viewer will view the content one still frame at a time.

### EXAMPLE 1

A catalogue for “Claudia's Closet,” a retailer of women's lingerie, sleepwear, swimsuits and accessories. The goal is to create Step-frame Video Content that looks like and can be used in a similar way to the retailer's traditional paper catalog. In this example, all of the content of each frame is intended to be viewed in stepped-frame mode.

There are 3 main steps:

Step 1 is Creation of “pages.” Using computer graphics software such as Adobe Photoshop, create individual “pages” (files) that combine photos and text like the pages of a paper catalogue.

Step 2 is importing the “pages” into an editor. Import the individual Page Files into a computerized nonlinear editing system such as Avid for editing.

Step 3 is Sequencing the “pages.” Use the nonlinear editor to edit together the Page Files in the proper sequence. The resulting Step-frame content can then be broadcast. Alternatively, the resulting Step-frame content can be edited together with other real time and/or Step-frame content as part of a program or commercial and then broadcast as combined content.

Step 1: Creation of “Pages.”

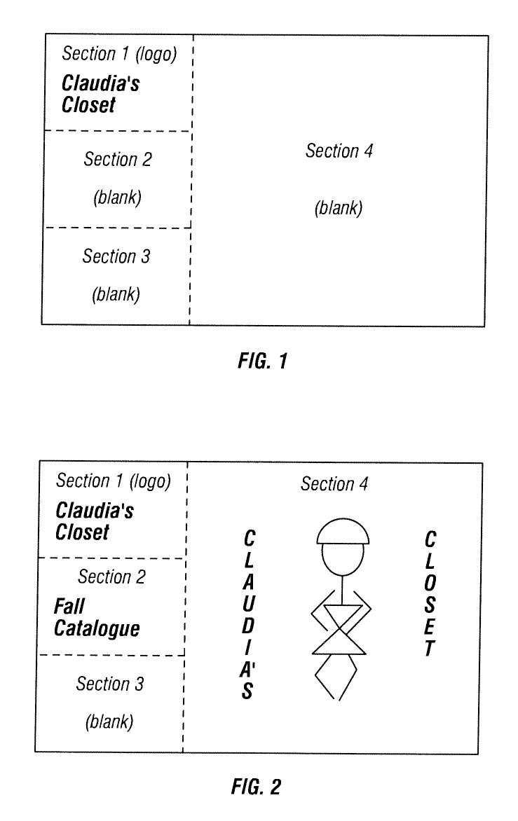

Create a single-frame Master File, using computer graphics software such as Adobe Photoshop. (FIG. 1) This Master File will serve as a template for all of the individual catalogue “pages.” In our example, the Master File will have 4 Sections:

The company logo

Category text (“Lingerie,” “Sleepwear,” “Swimwear,” “Clothing.” “Footwear.”.)

Page number

Photo(s) of the individual items for sale, combined with descriptive text, prices, etc.

Insert the company logo in Section 1 (see FIG. 1), and any other graphics or background art common to all pages of the catalogue into the Master File. Leave Sections 2, 3, and 4 blank. Save as the Master File.

Create a series of single-frame files for Section 4 (see FIG. 1) of each page of the catalogue plus the cover page. Each of these files will consist of combining relevant photos, text and graphics using computer graphics software such as Adobe Photoshop.

Create a Cover Page. Take one copy of the Master File and insert the “Cover” graphic file (created in Step B) in Section 4 of the Master File, and insert the Cover Page text into Section 2. Save the Cover Page File. (FIG. 2)

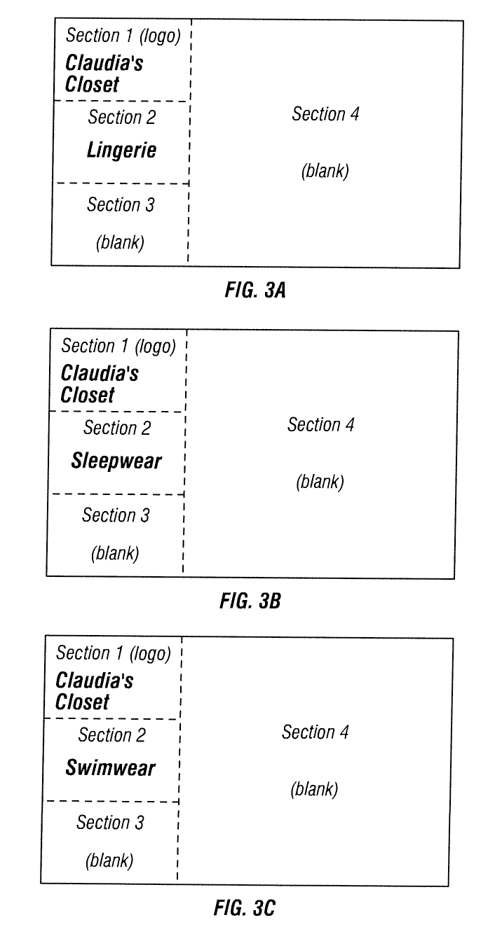

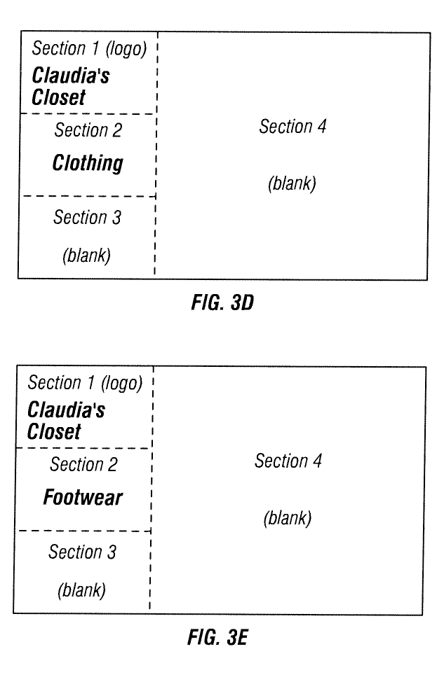

Create a series of Category Sub-Master Files, one for each category, e.g., Lingerie (FIG. 3a), Sleepwear (FIG. 3b), Swimwear (FIG. 3c), Clothing (FIG. 3d), and Footwear (FIG. 3e). Using copies of the Master File, insert specific Category text into Section 2. Sections 3 and 4 are blank. Save these Category Sub-Master Files. These Category Sub-Master Files will serve as templates to create individual Page Files.

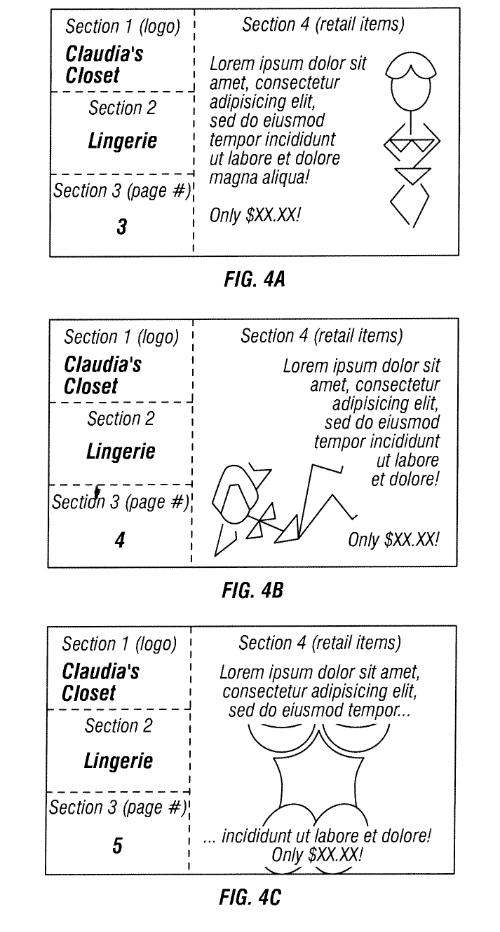

Create all the individual pages in the Lingerie Category. Using the Lingerie Sub-Master File (FIG. 4a), insert the first Lingerie “page” file into Section 4. Place a page number in Section 3. This first page number will be 3 (the Cover is page 1, the Table of Contents will be page 2). Save this new assembly as a Page File. Repeat this process for all Lingerie pages, numbering sequentially as shown in FIGS. 4b-4c. Assuming there are 20 Lingerie pages, they will be numbered 3 through 22. Once completed, each of the 20 Lingerie pages will be alike in sections 1 and 2, with different page numbers in section 3 and different content in Section 4.

Create and save all the individual Page Files for the remaining Categories in the same manner as in Step 1E above. Number the pages accordingly so that each page of the catalogue has a unique number.

Create and save Table of Contents Page File. Number this page, Page 2.

Create and save any other miscellaneous individual Page Files in the same manner, for example an index page, a how-to-order page, etc.

Step 2: Importing the “Pages” into an Editor.

Import the individual computer graphics Page Files into a computerized nonlinear editing system such as Avid.

Step 3: Sequencing the “Pages.”

Use the nonlinear editor to edit together the Page Files in the proper sequence. The resulting stepped-frame content can then be broadcast. Alternatively, the resulting stepped-frame content can be edited together with other real time and/or stepped-frame content as part of a program or commercial and then broadcast as combined content.

It is also possible to use a variation of this process to create a form of stepped-frame video content in which certain sections of each frame are intended to be viewed as conventional real-time video, while other sections of each frame are intended to be viewed in stepped-frame mode. For example, it would be possible to create stepped-frame video content in which the left half of the video screen appears to be a conventional real-time video Claudia's Closet TV commercial, while the right half of the screen is the Claudia's Closet stepped-frame catalogue.

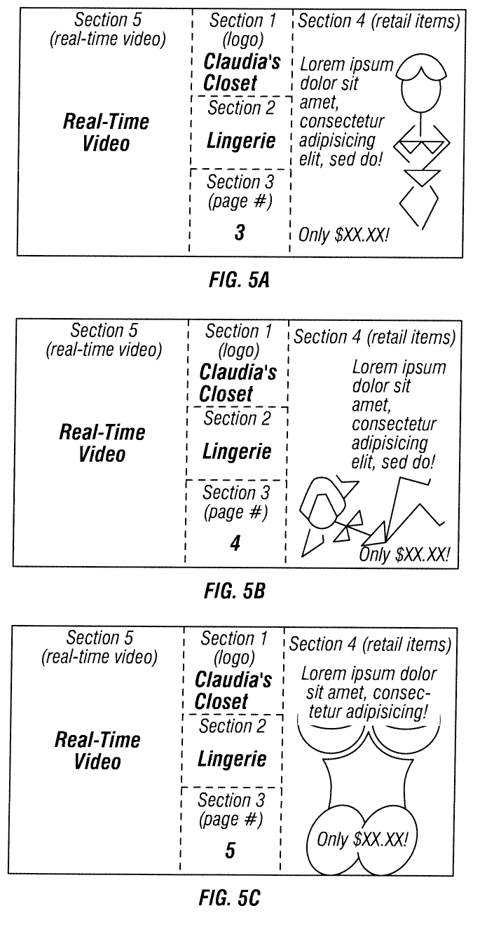

This could be done by creating a fifth section of each frame of the catalogue as described above, such section being on the left-hand side of each frame (FIG. 5), and inserting within such section individual frames of the real-time video commercial, using standard computer-graphics and video editing technology. (FIGS. 5a, 5b, and 5c).

### EXAMPLE 2

A commercial for a car, say, the new 2007 Cromwell Saloon. In this example, at least a portion of the TV screen will contain conventional real-time video all the way through, but part of the commercial will also contain stepped-frame content in a portion of the screen.

There are 3 main steps:

Step 1: Creation of the real-time part of the commercial.

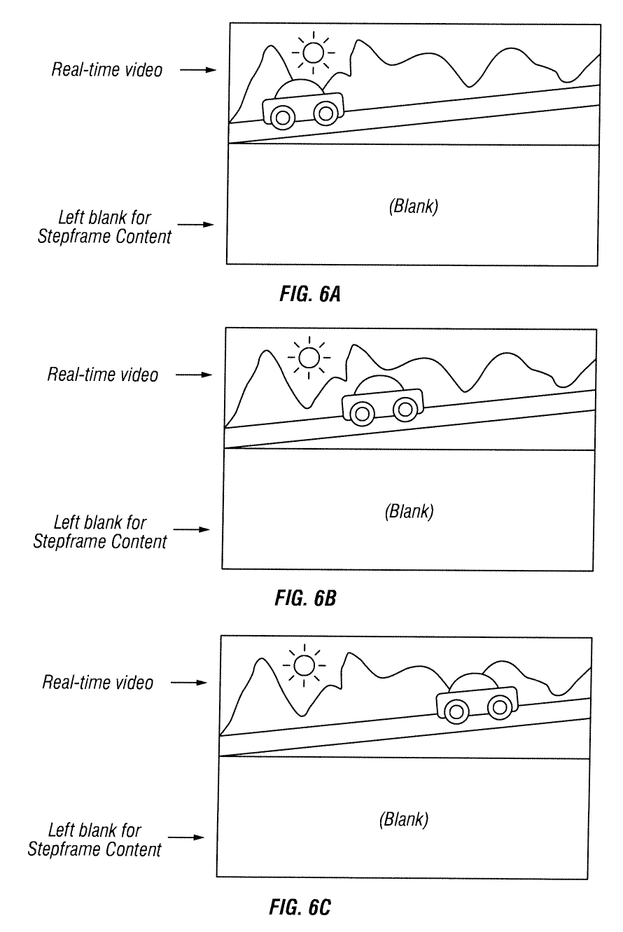

Film the 2007 Cromwell racing through mountains and deserts, parked at a fancy country club, etc. Record voiceover and music. The beginning of the voiceover might say, “Introducing the Cromwell Saloon—new for '07!” while we see a full-screen shot of the car. Then the voiceover might talk about luxury, performance, styling, and so forth, while we see the car racing up mountain switchbacks and breaking the speed limit in the desert. During this section, however, the real-time video of the car is confined to the top half of the screen, while the bottom half is left blank. (FIG. 6) The conclusion of the commercial could be conventional, full-frame real-time video.

Step 2: Creation of the stepped-frame content of the car commercial.

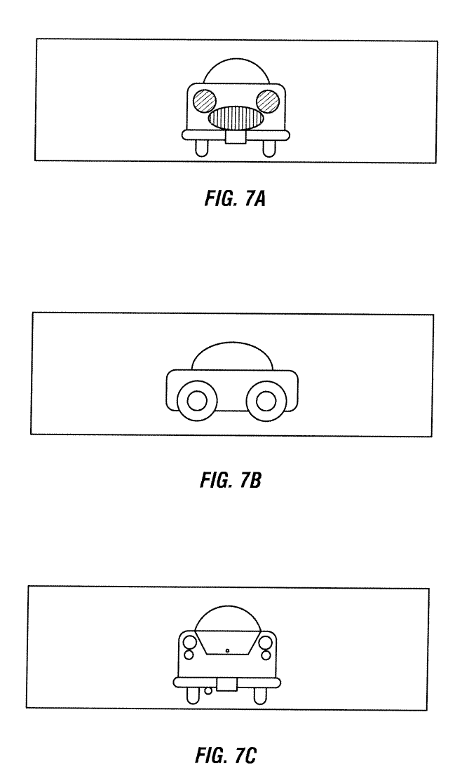

Take still photographs of the exterior of the car from several different angles. Repeat this exact process for every color the car comes in. Or, alternatively, take only one series of still photos and, using Photoshop or the like, make a series of photos in every color. Then follow these steps to make series of photos of the available interior colors and trim options as well. Crop these photos to the proportions of the blank areas in the previously created real-time video. (FIG. 7).

Step 3: Putting the stepped-frame content in the blank sections of the video.

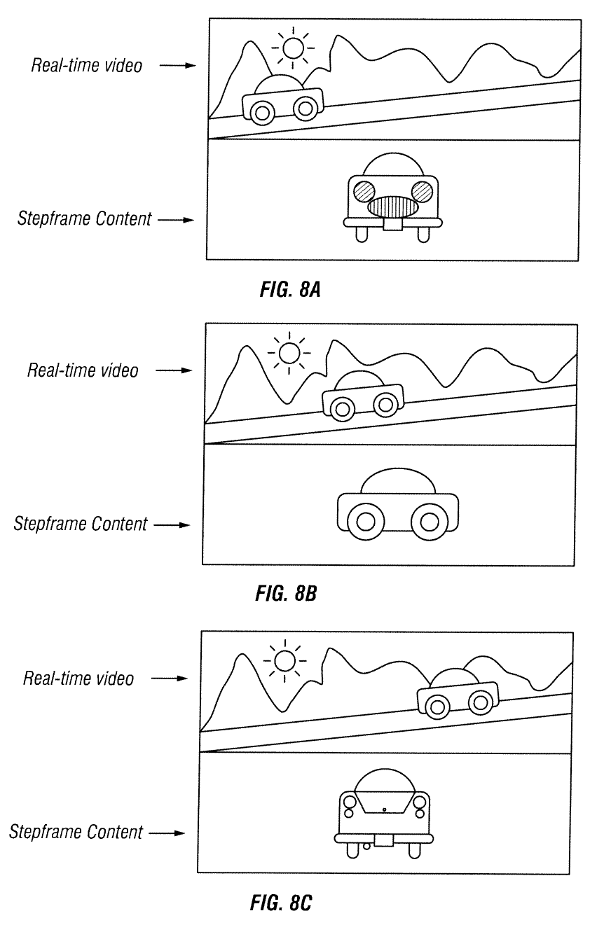

Using a nonlinear video editor, insert the still photos of the car (every angle/color/interior option) in the blank bottom sections of the individual frames of the real-time mountain and desert video. (FIG. 8). When this finished, and commercial is played back from a PDVR, the viewer then has the option of watching the middle mountain/desert video in real-time, or perusing all the angles, colors, and interiors in stepped-frame mode.

An essence of the current invention is therefore to produce programs, commercials and other types of content that are specifically intended to be viewed in stepped-frame mode, i.e. one frame at a time, and viewed at a rate and for a period of time chosen by the viewer that allows them to see every piece of detail contained within each individual frame. In this method, content, and particularly video content, is produced with the intent that it will be recorded as it is initially broadcast or transmitted, but will then be viewed at some future time in step-frame/frame-advance mode.

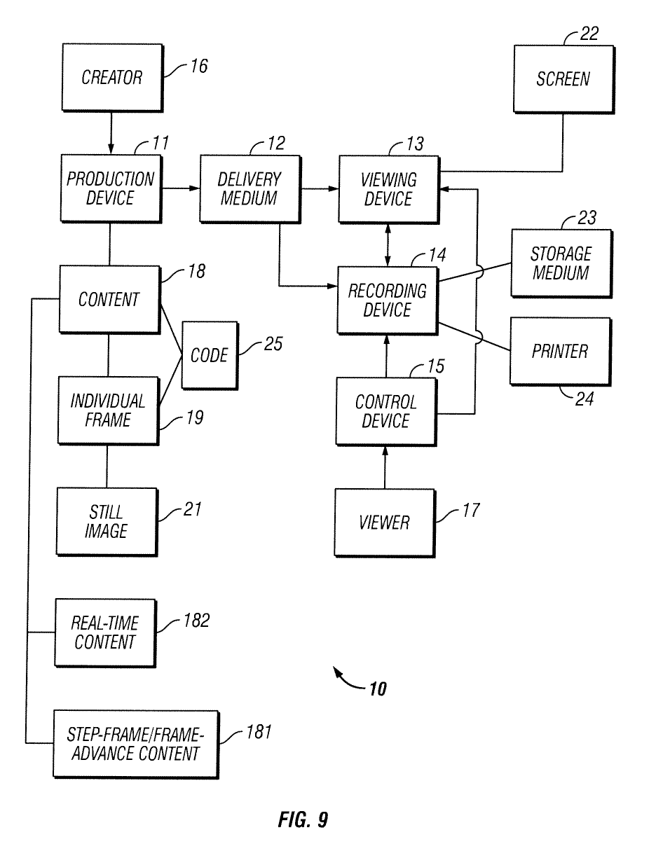

FIG. 9 is a block diagram schematically representing a content production and delivery system, such as an advertisement and information system 10, according to one exemplary embodiment of the present invention. The advertisement and information system 10 may include a production device 11, a delivery medium 12, a viewing device 13, a recording device 14, and a control device 15. The delivery medium 12 may include, but is not limited to, television broadcast distribution, cable distribution, internet distribution such as by video streaming, wireless distribution, and satellite distribution. The viewing device 13 may include, but is not limited to, video monitors, television sets, computers, cell phones, PDA's, and gaming devices. Television sets may include sets having a standard resolution and sets having a high definition resolution, and which may be able to receive analog and/or digital signals. The viewing device 13 may include a screen 22 or utilize a separate monitor. The recording device 14 may be any device that includes a storage medium 23. The storage medium 23 may be, for example, a hard drive. Recording devices 14 may include, for example, videotape recorders (VTR), digital videodisc recorders, personal digital video recorders (PDVR's), computer hard drives, personal digital media players, or similar means.

The production device 11 may be used by a creator 16 to produce content 18, such as, but not limited to, advertising content, entertainment content, informational content, and educational content to be viewed by a viewer 17. Content 18 may include stepped-frame content 181 that may be intended to be viewed only in stepped-frame mode as a series of still images that can be viewed one frame at a time at a speed and direction (forward and/or backward) determined by the viewer 17. The stepped-frame content 181 may be created from images of source material, such as catalogue pages, brochure pages, photographs, images and/or data. The stepped-frame content 181 may be interactive, for example, by including a link to a Website and/or the Internet, by including direct links to a phone number, such as dial from your computer or set top box, etc, by being printable, or by sending the content 181 to a computer or other device. Content 18 may further include real-time content 182 to be viewed in real time. The content 18 may be encoded for electronic identification and may include a code 25.

The production device 11 may be used to produce content 18 as a sequence of individual frames 19 of still images 21. Thus, step-frame/frame-advance content 181 may be a sequence of individual frames 19 intended to be viewed in stepped-frame mode, where the viewer 17 moves forward and/or backward through the content 181 and views a sequence of individual frames 19 one frame at a time. The viewer may spend as much time as desired looking at each individual frame and may move forward and/or backward from frame to frame as desired. Furthermore, real-time content 182 may be a sequence of individual frames 19 intended to be viewed in real-time mode, where the viewer 17 sees a motion picture, which is a rapid sequence of individual frames 19 of still images 21, for example 30 individual frames 19 per second.

Each frame 19 or sequence of individual frames 19 may be encoded in such a way that the recording device 14 can electronically identify them. These electronically encoded identifiers could be used for purposes including but not limited to: 1. Identifying an advertisement by its retail category sponsor i.e. Cars, Cameras, Watches; 2. Identifying an advertisement by its specific sponsor, i.e. BMW, Nikon, Rolex; 3. Identifying content by demographic target, i.e. Senior Women, Basketball fans, Overweight Men;

These encoded identifiers could also be used to mark the beginning and end of stepped-frame video content or the beginning and end of various sections of stepped-frame video content. For example, in the case of the Claudia's Closet Catalogue, these identifiers could be used to mark the beginning and end of the catalogue, plus the beginning pages of each section (Lingerie, Sleepwear, Swimwear, etc.) of the catalogue. Examples of electronic identifiers include vertical blanking interval user bit codes, added video-black and/or audio-black pages between sections, and the like, these identifiers being intended to be automatically read by a PDVR, allowing the user of such PDVR to navigate quickly between sections of stepped-frame video content.

An alternative to electronic identifiers would be the inclusion of real-time video content that alerts the user to the start of a section of stepped-frame video content. This could be achieved by inserting a countdown similar to a standard Academy Leader before the start of the stepped-frame content. Another means would be to insert a real-time video indicator similar to the commonplace internet “loading bar.” before the start of the stepped-frame content.

The still images 21 may be designed to be viewed in stepped-frame mode only. Each individual frame 19 may further include still images 21 intended to be viewed in real time as moving images as well as still images 21 intended to be viewed in stepped-frame mode as still images. Thus, each individual frame 19 may include a section of real-time content 182 and a section of stepped-frame content 181.

For example, one part of each frame 19, such as the top half of the frame 19, may include images 21 that when viewed sequentially in real time will produce a typical moving image, such as a traditional television commercial with associated sound, while another part of each frame 19, such as the bottom half of the frame 19, may include still images 21, such as one or more photographs, data, and supplemental information, for example from a catalogue or brochure, that are viewable in stepped-frame mode. Thus, when viewed in real time, the viewer 17 sees a traditional television commercial in the top half of the screen 22 of the viewing device 13. Then when watched in stepped-frame mode, the viewer 17 will see individual still frames 19 of the commercial in the top half of the screen 22, and individual pages of the content 18, such as a catalogue or brochure, in the bottom half of the screen 22. Current television is technically watched one frame at a time, but is watched at approximately 30 frames per second so that it produces the effect of moving images, whereas the present invention in one embodiment produces content that is viewed one frame at a time at the user's speed so they can read and look at the content in the same way as they would read a book, or catalogue or brochure or other printed matter, etc.

Also, a part of each frame 19 may include images of animated characters or other moving images that when viewed in real time can be seen or heard by the viewer 17. The animated characters or moving images seen in real time may provide information to the viewer 17 on what content 18 can be found in the individual frames 19 when watched in stepped-frame mode.

Furthermore, the production device 11 may be used to produce a sequence of still images 21 intended to be viewed in real time in combination with a sequence of still images 21 intended to be viewed in stepped-frame mode. Both of these sequences may then be edited together by adding to create a single final sequence. Editing both sequences together means that the sequence of still images 21 intended to be viewed in real time may be combined with the sequence of still images 21 intended to be viewed in stepped-frame mode to be connected by adding. The final sequence may include the sequence of still images 21 intended to be viewed in real time and the sequence of still images 21 intended to be viewed in stepped-frame mode in succession and may have a length equal to the lengths of both of these sequences added together. The sequence of still images 21 intended to be viewed in stepped-frame mode may be added at the beginning, somewhere in the middle, and/or at the end of the sequence of still images 21 intended to be viewed in real time.

The delivery device 12 may transmit the content 18 final sequence at a standard frame rate or any other frame rate, for example, a faster than standard frame rate, to the viewing device 13 and the recording device 14. The viewing device 13 can receive the final sequence. If content 18 includes sequences of frames 19 that are intended to be viewed in real time, these may be instantaneously viewed by the viewer 17 on the viewing device 13. The recording device 14 may also receive the transmitted final sequence and may record it. The final sequence may be recorded to and saved in a storage medium 23, which may be part of the recording device 14.

The viewer 17 may access content 18 at any desired time thereafter. The recording of content 18 may be played back in stepped-frame mode using the recording device 14 and may be viewed by the viewer 17 on the viewing device 13 one frame 19 at a time pausing at each individual frame 19 for as long as needed to read the content 18 or for as long as desired, similar to turning the page of a book one page at a time. It may further be possible to move back and forth from frame to frame just like turning pages of a book back and forth.

The recording device 14 may be operated manually to record content 18 that has been transmitted and received. The recording may take place at the same time the viewer 17 watches real-time content 181 in real time on the viewing device 13 or without displaying any content on the screen 22 of the viewing device 13. Additionally, the recording device 14 may be programmed in advance to record content 18 that will be transmitted and received. If the content 18 is encoded, the recording device 14 may be programmed in advance to automatically search for and record content 18 that includes a certain code 25. It may be possible to program a variety of codes 25 to record a variety of content 18. Thus, content 18 containing specific information desired by the viewer 17 may be automatically recorded.

The control device 15 may be remote control operated by the viewer 17. The control device 15 may be used to control the viewing device 13 and the recording device 14. The control device 15 may be used, for example, to turn the viewing device 13 and the recording device 14 on and off, to access the storage medium 23 to select content 18 for replay, and, most importantly, to move forward and/or backward from one frame 19 to the next frame 19 equivalent to turning one page at a time of the original source material, such as a catalogue or brochure. It may also be possible to automatically advance from one frame 19 to another frame 19.

After content 18 has been received, content 18 may also be printed on a printer 24 connected to the recording device 14. Furthermore, content 18 may include links to Web pages so that a viewer 17 while viewing, for example, a catalogue can immediately click on a link to a Web page, where the viewer 17 may place an order. Still further, content 18 may include the ability to directly place a telephone call, for example, to potential advertisers and retailers. Also, the individual frames 19 may include other information and content that are incentives for viewers to record and replay the frames in stepped-frame mode. For example, these frames 19 may include discount coupons, ways to receive free gifts, competitions, clues to correctly enter and win competitions, news of future television programs, television schedules, recipes, “do-it-yourself” instructions, special promotions, clues to computer games the viewer may own or buy, quiz shows and/or game shows including questions and answers, paid advertisements by other advertisers, and the like. Such content can be produced using a graphics program such as Photoshop, and inserted as individual frames or sections of frames. These frames can then be edited together using an AVID as shown in the examples of how to create step-frame content.

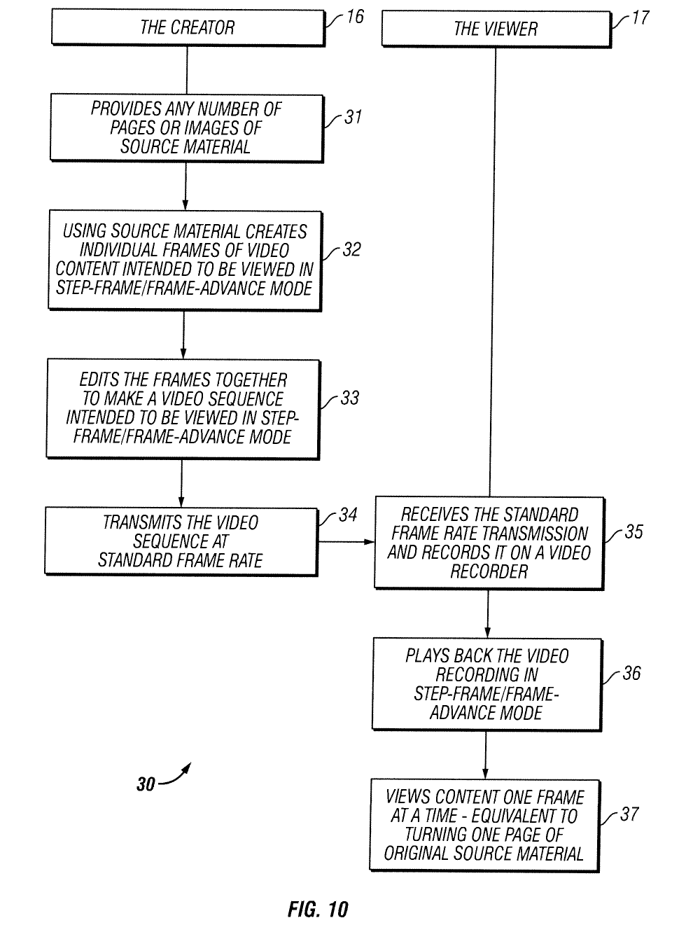

FIG. 10 schematically represents a series of steps involved in a first method 30 for providing stepped-frame content 181, according to another embodiment of the present invention. Method 30 may involve a step 31, where a creator 16 may provide any number of pages or images of source material of content 18. Step 32 may involve using the source material to create individual frames 19 of content 18, which may be intended to be viewed in step-frame/frame-advance mode. Thereafter, in step 33, individual frames 19 may be edited by the creator 16 by combining a plurality of individual frames 19 to be connected to make a video sequence intended to be viewed in stepped-frame mode only. The video sequence of the content 18 is then in a step 34 transmitted at a frame rate, for example, a standard frame rate, by the delivery device 12.

Thereafter, the transmitted content 18 may be received and recorded by the recording device 14 in step 35. The following step 36 may involve playing back the recorded content 18 in stepped-frame mode with the recording device 14 followed by a step 37, where the viewer 17 views the content 18 one frame 19 at a time displayed on the screen 22 of the viewing device 13. Viewing the content 18 may be equivalent to turning the pages of the source material.

After viewing the content 18, content 18 may be saved using a storage medium 23 for repeated viewing at later times or may be printed as reference using the printer 24. Method 30 may also be used, for example, to deliver stepped-frame content 181, such as, but not limited to, books, research articles, and telephone books (known as “white pages” and “yellow pages”).

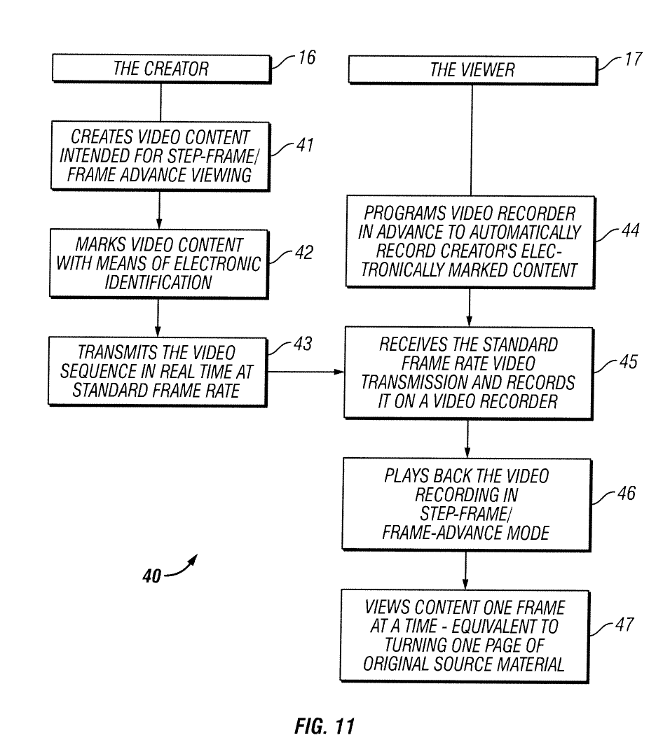

FIG. 11 schematically represents a series of steps in a second method 40 for providing encoded stepped-frame content 181, according to another exemplary embodiment of the present invention. Method 40 generally differs from above presented method 30 by enabling the encoding of individual frames 19 or sequences of individual frames 19 of the stepped-frame content 181. Method 40 may involve a step 41, which may involve creating content 18 intended for stepped-frame viewing only, where a viewer 17 moves forward and/or backward through the stepped-frame content 181 by viewing a sequence of individual frames 19 one frame at a time, spending as much time looking at one frame as desired, comparable to turning the pages of a book. In step 42, the creator of the content 18 marks the content 18 with means of electronic identification. Therefore, each individual frame 19 or a sequence of individual frames 19 of the content 18 may be provided with a code or descriptive word 25, which allows electronic identification of the specific content 18. Code 25 may be related to the content 18 or other criteria. Thereafter, in a step 43, the content 18 may be transmitted at a standard frame rate or a faster than standard frame rate by the delivering device 12 to the recording device 14.

Independent from and prior to or at the same time as step 43, the viewer 17 may program the recording device 14 to automatically search, identify, and record the transmitted encoded content 18 according to individual criteria of the viewer 17 in step 44. In a step 45, the transmitted content 18 may be received, searched, and, if a desired code is identified, recorded by the recording device 14. The following step 46 may involve playing back the recorded content 18 in stepped-frame mode with the recording device 14 followed by a step 47, where the viewer 37 views the content 18 one frame 19 at a time displayed on the screen 22 of the viewing device 13. Each individual frame 19 of the content 18 may be displayed on the screen 22 of the viewing device 13 for as long as desired by the viewer 17.

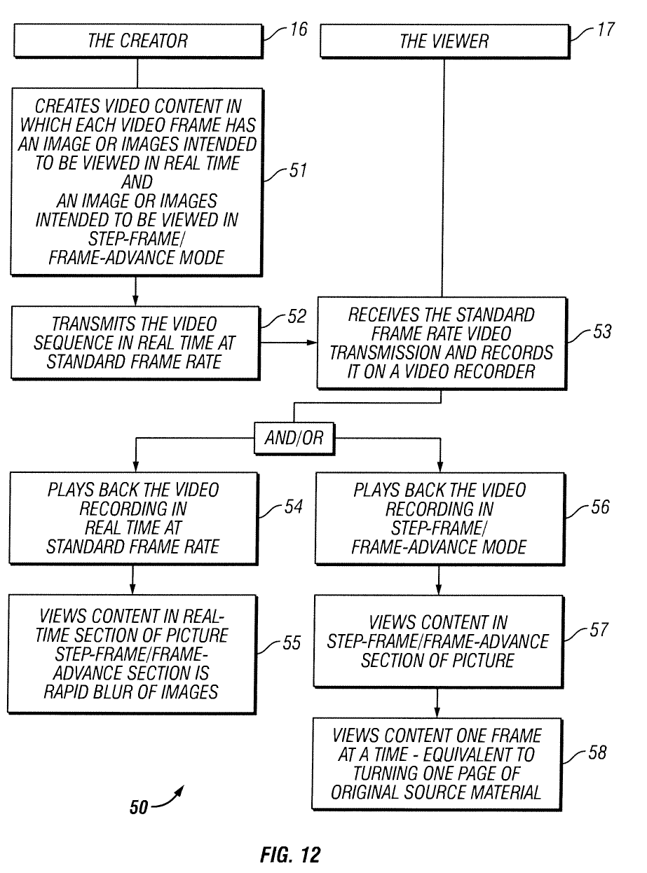

FIG. 12 schematically represents a series of steps involved in a third method 50 for providing real-time content 182 and stepped-frame content 181 combined in an individual frame 19, according to another embodiment of the present invention. Method 50 generally differs from the above described methods 20 and 30 by enabling combination of the stepped-frame content 181 and the real-time content 182 in a single individual frame 19. Method 50 may involve a step 51 in which the creator 16 uses the production device 11 to create a sequence of individual frames 19, where each individual frame 19 may include still images 21 intended to be viewed in real-time as well as still images 21 intended to be viewed in stepped-frame mode. Thus, each individual frame 19 may include a section of real-time content 182 and a section of step frame/frame-advance content 181. A following step 52 may involve the transmission of the sequence of individual frames 19 at a frame rate, for example, a standard frame rate, by the delivery device.

The transmitted sequence of individual frames 19 may be received and recorded by the recording device 14 in a step 53. The transmitted sequence of individual frames 19 may further be received by the viewing device 13 and the still images 21 intended to be viewed in real-time mode may be displayed on the screen 22 and may be viewed by the viewer 17, in a manner such as a typical television program or conventional commercial would be watched. In step 54, the recording may be played back in real-time mode at standard frame rate using the recording device 14 and, in a following step 55, the recording may be viewed in real-time mode at a standard frame rate on the viewing device 13. While the viewer views the real-time content 182 in real time, the stepped-frame content 181 appears only as a rapid blur of images on the screen 22 of the viewing device.

Furthermore, in a step 56, the transmitted sequence of individual frames 19 may be played back in stepped-frame mode using the recording device 14. A following step 57 involves viewing the step-frame/frame-advance content 181 in the section of stepped-frame content 181 of the frame 19. The viewer 17 may view the stepped-frame content 181 one frame 19 at a time just like turning a page of original source material in step 58.

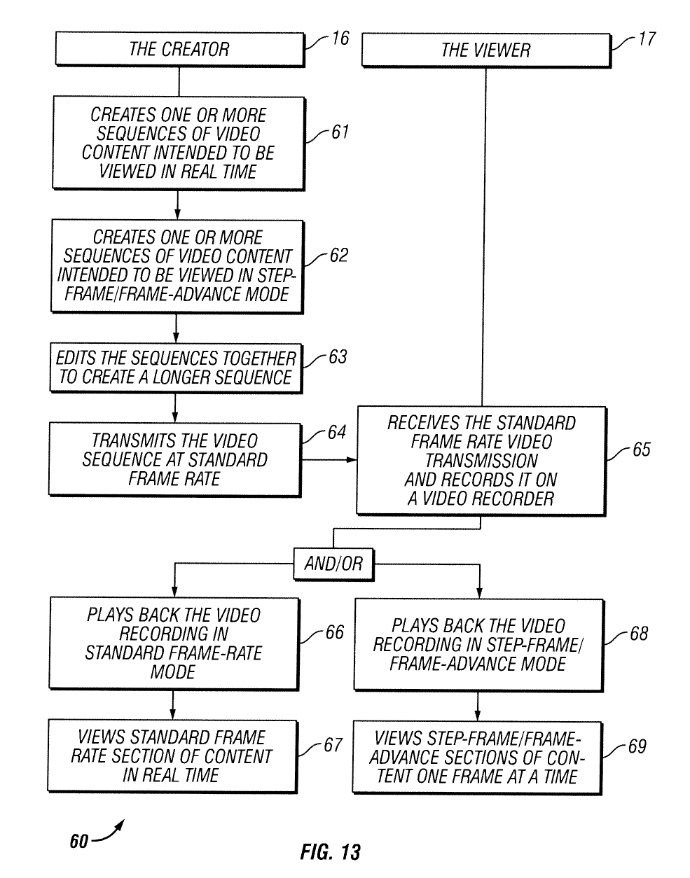

FIG. 13 schematically represents a series of steps involved in a fourth method 60 for providing content 18 by sequentially combining real-time content 182 with stepped-frame content 181, according to another embodiment of the present invention. Method 60 generally differs from the above described methods 30, 40 and 50 by supplementing the real-time content 182 with the stepped-frame content 181 such that the real-time content 182 is included in one or more first sequences of individual frames 19 and that the stepped-frame content 181 is included in one or more second sequences of individual frames 19 that may be put together in succession.

Method 60 may involve a step 61 that involves creating one or more sequences of individual frames 19 of real-time content 182 that are intended to be viewed in real time. A following step 62 involves creating one or more sequences of individual frames 19 of stepped-frame content 181 that are intended to be viewed in stepped-frame mode. The real-time content 182 and the stepped-frame content 181 may relate to a same topic. The creator 16 can edit the sequences including real-time content 182 and the sequences including stepped-frame content 181 together to be in succession without overlapping to create a final sequence in step 63. A step 64 may involve transmitting the final sequence at a frame rate, for example, a standard frame rate, to the viewing device 13 and to the recording device 14 by using the delivery device 12.

Thereafter, the recording device 14 may receive and record the final sequence in step 65. The final sequence may also be received by the viewing device and the real-time content 182 may be viewed in real-time mode by a viewer 17 instantaneously without prior recording. A step 66 may involve playing back the recorded final sequence in real-time mode and a viewer 17 may view the real-time content 182 in real-time. Furthermore, a step 68 may involve playing back the recorded final sequence in stepped-frame mode and a viewer 17 may view the stepped-frame content 181 one frame 19 at a time in step 69.

For example, in one preferred embodiment an advertiser can utilize this method to produce a non-traditional “stepped-frame” commercial that is in essence 900 pages of a catalogue, brochure, or print advertising campaign. When watched in real time, the pages of the brochure will flash by the viewer. When watched in stepped-frame mode, however, each individual page will be a discrete frame containing photographs, images and/or data similar to that seen in the print brochure or catalogue, etc. In addition, when such frames are broadcast in “high definition” or “HD” and viewed on a television with high definition capabilities, the photographs, images and/or data may be viewed in high definition, with greatly enhanced clarity and detail, which may be of great value to an advertiser.

In another preferred embodiment, part of each frame, say the top half of the frame, may include images that when viewed sequentially in real time will produce a typical moving image such as a traditional television commercial with associated sound, while another part of each frame, say the bottom half of the frame, may consist of one or more photographs, images, and/or data from a catalogue or brochure. Thus when viewed in real time the viewer sees the traditional high-impact television commercial in the top half of the screen with barely recognizable images in the bottom half of the screen. Then, when watched in stepped-frame mode, the viewer will see individual still frames of the commercial in the top half of the screen, and individual pages of the catalogue or brochure in the bottom half of the screen.

In yet another preferred embodiment, this method may be used to deliver a range of different catalogues, brochures or other print advertising during a longer period of time, say an hour. For example, the user of this method may buy time from a television channel, in the same way that infomercial producers currently buy time, in order to broadcast such a range. This will allow different advertisers to deliver brochures, catalogues and other print style advertising of different lengths, depending on the number of still images they wish to deliver.

In yet another preferred embodiment, as current and future technologies allow, this method will allow content to be delivered that may include photographs, images and/or data that can be printed on a home printer, such as discount coupons that a viewer can print and take to a store.

In yet another preferred embodiment, as current and future technologies allow, this method will allow content to be delivered that may include links to Web pages, so that a viewer of a catalogue, for example, can immediately click on a link to a Web page where they can then place an order on a Website.

In yet another preferred embodiment, as current and future technologies allow, this method will allow content to be delivered that may include the ability to directly place telephone calls to potential advertisers, retailers, etc.

In yet another preferred embodiment, part of each frame may include images of animated characters, that when viewed in real time can be seen and heard by viewers.

In yet another preferred embodiment, the animated characters or moving images seen in real time may provide information to the viewers on what they may find in the individual frames when watched in stepped-frame mode.

In yet another preferred embodiment, the animated characters or moving images seen in real time may provide information to the viewers on how they can access the information using stepped-frame mode.

In yet another preferred embodiment, the individual frames can include other information and content that are incentives for viewers to record and replay the frames in stepped-frame mode. For example these frames may include discount coupons, ways to receive free gifts, competitions, clues to correctly enter and win competitions, news of future television programs, television schedules, recipes, “do-it-yourself” instructions, special promotions, clues to computer games the viewer may own or buy, quiz shows and/or game shows including questions and answers, paid advertisements by other advertisers, and the like.

In yet another preferred embodiment, this method could be used to provide a viewer with essential information that is difficult to retain as part of a real-time video program. For instance, a half-hour cooking show with an actual running time (excluding commercials) of 23:30 could devote 22 minutes, 14 seconds, and 27 frames to demonstrating the preparation of a dish. It could then include the written recipe and other instructions in 3 stepped-frame still images.

Production credits for a program could be handled the same way. At present, credits are either a series of “freeze frames” at the end of a program or a “crawl.” In either case, often the individual credits are either on screen for too short a time, in too small a typeface, or “crawling” too rapidly to be legible. But by using the invention, every credit could be legible while taking up negligible real-time running time. Political pecking order could still be observed with the Director getting a frame to himself while the Production Assistants are listed 8 to a frame.

In yet another preferred embodiment, where current and new technologies allow, each frame or series of frames will be coded in such a way that they can be easily identified by such current and new technologies. For example certain PDVR's have a search feature that allows the user to program the PDVR to search for particular programs that may be of interest to the viewer. For example, such PDVR's may be programmed to search for any movie that is being shown on any channel that a particular actor is in. It is thus anticipated that some current and future such devices will allow viewers to program these technologies to search for and record specific content produced under this method, such as catalogues and brochures on particular products. For example, if a viewer is interested in buying a new car, he may program his PDVR to search for and record all brochures being broadcast or shown on all cars, or on a particular brand of car, or a particular type of car (say SUV's) or all cars in a particular price range, and the like. In fact, TiVo® has recently announced that they are working with a number of leading advertising agencies to offer just such a search and retrieve function on future PDVR's for searching and retrieving traditional television commercials.

In yet another preferred embodiment, as current and new technologies allow, content produced under this method can be delivered to and watched/used by viewers who will view this content on any other device that incorporates technology that allows some form of recording of content and some form of playing back such recorded content in stepped-frame mode, such as future versions of PC's, laptop computers, cell phones, PDA's, etc.

In yet another preferred embodiment, producers may use this method to enhance actual programs rather than commercials. For example, producers of game shows or quiz shows may use such techniques to allow viewers to participate in a quiz or game show from home by posting a series of questions that viewers can record and later view in stepped-frame mode. In another example, producers of a documentary may use such techniques to send the viewer additional background information on the program or subject being covered in the documentary, or details on how to donate to a charity supporting a cause being covered in a particular program, or how to buy DVD's of the program, etc. A producer of a drama show or sitcom may send viewers information on how to purchase clothing or props that are similar to those being worn or used by the cast, etc.

In yet another preferred embodiment, this method may be used to deliver other forms of written material and/or photographs. For example, stepped-frame content could be used to view books, to research articles, and the like that have been sent to the viewer and recorded on their recording devices.

In yet another preferred embodiment, this method may be used to allow viewers to read and answer test questions. For example, a viewer may be able to take his Real Estate examination on a television screen using stepped-frame pages.

In yet another preferred embodiment, this method may be used to deliver other information about programs or commercials; i.e. legal disclaimers/medical side-affects, warnings, and other mandatory legal copy. Currently, many TV advertisers must include visible mandatory legal disclaimer copy in their real-time commercial broadcasts. Some examples are promotions of sales, contests, lotteries, ads for pharmaceuticals, etc. While law mandates these disclaimers, each TV and cable network has its own staff to enforce and interpret compliance in individual commercials. Thus, a nationally broadcast TV commercial, to satisfy the compliance criteria of, say, NBC™, CBS™, ABC™, FOX™, CNN™, and ESPN™, may have to be produced with 6 different versions of the on-screen disclaimer language, with 6 different requirements for the size and kind of typeface.

Aside from the production difficulties, advertisers dislike the superimposition of these disclaimers onto their video footage because it detracts from the aesthetics and impact. So they try to make the disclaimers as brief and in as small a typeface—as invisible—as the individual networks will allow. While intending to comply with the law, the networks also try to please their paying customer, the advertiser. So inevitably, often following prolonged acrimonious negotiation, a compromise is reached whereby the onscreen disclaimer is both unsatisfactory to the advertiser and illegible to the viewer. It's an all around losing proposition.

The invention, however, can provide the ideal solution to this problem. By creating a single or multiple images of the disclaimer language to be viewed in stepped-frame mode: 1. The effectiveness and impact of the advertiser's video footage would be undiminished, 2. Production of the various network versions would be easier, faster, and less expensive, and 3. The viewer would actually be able to read it.

In yet another embodiment: an advertisement for a car. The video content consists of a 300-frame sequence. The top ¾ths of each frame is a different still image of the car. The bottom ¼ of each frame, however, says this: “SNEAK PEEK . . . THE ALL NEW FORD MUSTANG™.” So when the viewer initially sees the advertisement in real time, he sees 10 seconds of the words “SNEAK PEEK . . . THE ALL NEW FORD MUSTANG™” at the bottom of the picture (and, perhaps, hears a voiceover saying, “Here's a sneak peek at the all-new Mustang!”), while the top of the picture is a 10-second blur of rapidly changing images.

Then when the viewer steps through the same material, he sees up to 300 different still images, possibly including but not limited to: the exterior of the car; the interior; the engine compartment; safety features; mileage data; available optional equipment; color choices; warranty information; pricing; in the top ¾ of the 300 frames.

In yet another embodiment: a TV network self-promotion. The video content consists of a 150-frame sequence. The face of an animated character is in a square insert at the top left of each frame. As the content plays in real time (5 seconds), the animated character says, “Hey kids! Check it out! It's all happening right here on KIDS' WB!™”.

When the viewer steps through the video, he finds many kinds of promotional content, possibly including but not limited to: single-frame promotions with images and captions for upcoming shows; multiple-frame promotions, etc. For example, in a multi-frame promotion, Frame 1 contains the text “On the next CowBots . . . ”; Frame 2 contains the text “ . . . when Sheriff Cy Borg tracks down Mad Morphin' Murphy”; Frame 3 contains the text “ . . . it's mano a mano in a shape-shiftin' showdown!”; Frame 4 contains the text ‘Next CowBots. Right after America's Funniest Anime Bloopers on KIDS' WB!™” Additional frames may include contest information/clues; celebrity trivia; paid advertisements by other sponsors; “behind the scenes/making-of” images from animated or live-action shows; daily/weekly programming schedules, etc.

In another embodiment: a shared local-advertisement “pod.” Multiple advertisers would share the video content. In one example a 5-second (real time) local broadcast in the hypothetical town of Smootville would have a 5-second “banner” of text at the bottom of the picture reading: “FINE DINING IN SMOOTVILLE.” Various local restaurants would purchase either a single advertising frame or multiple frames and insert either a single image or multiple images within these frames to promote their establishments. A single-frame ad might be a simple name, address, operating hours and phone number. A multiple frame ad would possibly include but would not be limited to images of the restaurant interior, the food, the staff, the menu, etc.

In another embodiment: a shared national-advertisement “pod.” As in the previous example multiple advertisers would share the video content, but in this use, both the transmission and the target audience would be nationwide. By purchasing, at minimum, 1/30th of a second (or 1 frame) of national TV time, an advertiser could reach a targeted national audience at comparatively low cost. An example: during a national transmission of “It's a Wonderful Life,” a short “pod” is broadcast with the bottom text “banner” reading “CHRISTMAS TREES FROM MAINE.” The stepped-frame content would consist of numerous single- or multi-frame ads promoting individual Maine Christmas tree grower/shippers.

In another embodiment: a replacement for the traditional paper catalogue. The escalating costs of printing and shipping traditional paper catalogues have already driven some of the largest ones—for example those of Sears, JC Penney™, etc.—into extinction. However, by utilizing this method, catalogue content can be delivered to millions of consumers almost instantly, with no paper, printing, mailing, or fuel costs.

For example, at 30 pages (frames) per second, the 192-page Winter 2005 Staples™ catalogue can be delivered under this method (transmitted and recorded) in 6.4 seconds, without any paper, printing, mailing, or fuel costs.

In another embodiment: a catalogue delivered as part of a traditional “real time” TV commercial. Catalogue content would be included in the video content of a traditional commercial. As an example, again for Staples™, a TV voiceover might say, “You'll want to record this commercial, because now through Sunday, you can get 10% off our already-low catalogue prices on everything in the store. And speaking of the catalogue . . . , you're recording it right now!” The catalogue is then delivered as part of the commercial utilizing this method.

In another embodiment: automatic recording of catalogues and other content. Catalogues and other forms of content with high numbers of individual images would be scheduled to be broadcast at specific times. The audience member could then program his video recorder to receive and record that content automatically (using already-existing technology), to be played back at a later time.

In another embodiment: stepped-frame content for entertainment. The video content looks like any other traditional video when played at normal speed. However when viewed in stepped-frame mode, the content is revealed to be humorous or otherwise entertaining. An example would be video of a railroad crossing. At normal playback speed, a freight train whizzes by at 70 miles per hour. But when viewed in stepped-frame mode, the individual freight cars have jokes written on them.

In another embodiment: a replacement for the traditional telephone alphabetical order residential and business listings book, also known as a “white pages”. The traditional “white pages” phone book must first be printed and then hand-delivered to individual customers. Multiple books are often delivered to a single customer. These phone books are often large and heavy. For example, the SBC™ September 2004 Greater Los Angeles White Pages for Area Codes 323 and 213, which covers far less than half of the metropolitan area, runs some 775 pages and weighs over 4 pounds. It would be even bigger if SBCTM didn't use extremely small type to accommodate approximately 550 entries per page (5 columns×approximately 110 entries per column). Further, these traditional phone books are only updated, published and delivered once a year. Because of the time it takes between the update and delivery, traditional white pages are already outdated by the time they're delivered. And at the end of the yearly cycle, of course, they're even more outdated. Further, large metropolitan areas are often covered by multiple phone books, so a person trying to look up a number might not know which book he should be looking in. For example, imagine you're looking for the number of a person and all you know is his name and the fact that he lives somewhere in the Los Angeles area. He could live in Hollywood, Santa Monica, Burbank, Long Beach, Simi Valley, Saugus, or Pasadena. Each has a different area code and is covered by a different phone book. You either have to look in all 7 phone books (which you are unlikely to have) or you have to call Directory Assistance up to seven times, and be charged separately for each inquiry.

The invention, however, could be used to replace the traditional “white pages” phone book. There are several advantages, including but not limited to: no printing costs; no delivery costs; easily (and continuously) updateable; easier to read—there's no need to make the typeface small; wider coverage. Let's assume that in the case of the Greater Los Angeles directory, it is doubled in size to 1550 pages, so the typeface can also be twice as big. Further, let's assume that the other 6 Los Angeles-area directories are also 1550 pages each. So a “master” Los Angeles white pages directory (or PDVR White Pages) would be 10,850 pages in length. At 1 page per video frame, it could be transmitted and recorded in less than 6 minutes and 2 seconds.

In another embodiment: a replacement for the traditional telephone business listings book or “yellow pages”. The traditional “yellow pages” phone book must first be printed and then hand-delivered to individual customers. Multiple books are often delivered to a single address. These phone books are often large and heavy. For example, the SBC™ September 2004 Greater Los Angeles Yellow Pages for Area Codes 323 and 213, which covers far less than half of the metropolitan area, runs some 1060 pages and weighs over 5 pounds. It would be even bigger if SBC™ didn't use extremely small type to accommodate 5 columns of entries per page, with approximately 110 entries per column, not including display ads. Further, these traditional phone books are only updated, published and delivered once a year. Because of the time it takes between the update and delivery, traditional yellow pages are already outdated by the time they're delivered. And at the end of the yearly cycle, of course, they're even more outdated. Multiple yellow page books often cover large metropolitan areas, so a person trying to look up a number might not know which book he should be looking in. For example, imagine you're looking for the number of a business and all you know is its name and the fact that it is located somewhere in the Los Angeles area. That business could be in Hollywood, Santa Monica, Burbank, Long Beach, Simi Valley, Saugus, or Pasadena. Each has a different area code and is covered by a different phone book. You either have to look in all seven phone books (which you are unlikely to have) or you have to call Directory Assistance up to seven times, and be charged separately for each inquiry.

The invention, however, could be used to replace the traditional “yellow pages” phone book. There are several advantages, including but not limited to: no printing costs; no delivery costs; easily (and continuously) updateable; easier to read—there's no need to make the typeface small; wider coverage.

Let's assume that in the case of the Greater Los Angeles directory, it is doubled in size to 2120 pages, so the typeface can also be twice as big. Further, let's assume that the other six Los Angeles-area directories are also 2120 pages each. So a “master” Los Angeles yellow pages directory (or PDVR Yellow Pages) would be 14,840 pages in length. At 1 page per video frame, it could be transmitted and recorded in less than 8.5 minutes. In actuality, the Los Angeles PDVR Yellow Pages would probably be much smaller because many businesses currently run display ads in multiple (paper) yellow pages directories, and that redundancy would be cut out.

Another advantage is single-category recording. When, as it is anticipated will be the case, every PDVR Yellow Pages entry is “tagged” according to its business category, it would be possible to program a PDVR to automatically record only the section or category a consumer wants. (Being alphabetized, the PDVR Yellow Pages would already be organized in those distinct sections.) Let's say you need a new roof The “Roofing” section of the September 2004 SBC Greater Los Angeles Yellow Pages runs five and a half pages. So, using our previous method of extrapolation, there would be a total of approximately 38.5 pages of Roofing listings in the seven Los Angeles area Yellow Pages editions. Assuming there's no redundancy, at 1 page per video frame it would take less than 1.5 seconds to transmit and record the listings of every Los Angeles-area roofer.

In another embodiment: government and public service applications. The invention could be used to deliver images and information that are in the public interest. Examples include but are not limited to: missing persons; wanted fugitives; registered sex offenders; parolees.

Many parolees are severely restricted in their residence and travel options. By publicizing those restrictions, the public can potentially become aware that a person has violated his parole even before his parole officers find out.

In another embodiment: delivery of corporate annual reports. Public companies are currently required to print and mail annual reports to every stockholder. These annual reports are often costly both to print and to mail. And, ironically, doing so adversely affects those companies' profits and reduces the value of their shares.

Once the use of the invention becomes commonplace, it is anticipated that government regulations will be amended to allow companies to disseminate their annual reports using the invention.

In another embodiment: compulsory public notices. Many if not all local, county and state governments require business entities to publish notices (“statements”) in newspapers announcing the establishment of or changes in their businesses. An example would be the Los Angeles County Fictitious Business Names Statement requirement. For example, prior to opening a business, a business name must be selected that is not already in use and then registered. Business and Professional Code 17918 specifies “No person transacting business under a fictitious business name contrary to the provisions of this chapter, or his assignee, may maintain any action upon or on account of any contract made, or transaction had, in the fictitious business name in any court of this state until the fictitious business name statement has been executed, filed, and published as required by this chapter . . . state law requires that within 30 days the registrant must publish a statement in a newspaper of general circulation in the county in which the principal place of business is located.”

Once the use of the invention becomes commonplace, it is anticipated that government regulations will be amended to allow businesses to publish such statements using the invention.

One of the main benefits of the current invention is that whereas many viewers would typically use these new technologies to fast-forward or skip through traditional commercials that they will then never watch, it is anticipated that many of these viewers will be more inclined to record and watch stepped-frame commercials in the same way that they save and re-read print catalogues and brochures.

Another benefit of the current invention is that brochures and catalogues need no longer be printed and/or mailed.

Another advantage of the current invention is that there will be less waste of paper and postage to customers who have no interest in the products or services whatsoever.

Another advantage of the current invention is that catalogues, brochures, and print ads delivered by the current method will be much easier to store and access on a PDVR's or similar device.

Another advantage of the current invention is that it makes no difference if the viewer decides to skip over a commercial when watching a program, as they really need to watch this in stepped-frame mode in any event.

Another advantage of the current invention is that if PDVR's ultimately lead to the demise of the traditional television commercial, as some people are anticipating, then advertisers can use block purchases of time to broadcast content produced using the current method which can then be automatically recorded by PDVR's and similar devices to be watched at a later time at the viewer's discretion.

Another advantage of the current invention is that advertisers can get across a lot more information in a particular timeframe, such as within a 30-second spot, so that advertisers may share such time slots with other advertisers thus reducing their media buying cost.

Another advantage of the current invention is that the invention will allow for direct-mail-catalogue-style marketing in categories where it never previously existed. One such category might be vacation time-shares. A marketer of time-shares in a vacation property could produce a 30-image “catalogue” (deliverable in 1 second) and theoretically buy 1/900th of a half-hour of a late-night TV time slot, along with 899 other marketers of time-shares all over the world. The viewer/customer would then program his PDVR or similar device to record that late night broadcast, and then be in possession of 900 different 30-image time-share catalogues.

Another advantage of the current invention is that the drastically reduced production and delivery costs compared to traditional catalogues and brochures will “democratize” many product categories. In a category like, say, autos, manufacturers have always produced high-quality catalogues and brochures, but they've typically only made them available in their dealer showrooms, as the cost of these typically does not justify them sending these to people's homes through the mail. But the current invention will enable auto manufacturers to deliver those catalogues directly to the homes of a much wider audience of potential buyers who have not yet been enticed into the showroom, and at a significantly reduced cost. And those catalogues can contain much more information than before, since they don't have to be printed or mailed. An auto catalogue could have images of every model in every color from multiple angles. Consumers will also like this, as they will now be able to access the latest auto catalogues without having to go to the showroom.

Another advantage of the current invention is that the invention will make possible the creation of a “commercial/catalogue” hybrid in which, say, 27 seconds of a 30 second video production would be a traditional TV commercial message, but the other 3 seconds would contain a 90-page catalogue. So a retailer like IKEA™, who traditionally has done both TV commercials and direct catalogue mailings, could combine both in one video execution while eliminating all printing and postage costs.

Yet another advantage of the current invention is that at present, retailers who rely heavily on mailed catalogues and brochures must price their goods to offset the costs of catalogue or brochure printing and postage. By utilizing the invention, that portion of the retailers' overhead would be eliminated, enabling them to reduce prices across the board with no compromised in quality or profitability. Also, new startup companies utilizing the invention can spend far less (or none) of their initial capital on traditional direct marketing, making their odds of success much greater. These startups will also be better able to undercut the pricing of their bigger, established, direct-mailing competitors, driving prices down in general and benefiting consumers.

Another advantage of the current invention is that a viewer will be able to view the information and photographs within these individual frames in very high quality and in a much larger size than available in current print ads, brochures or catalogues. For example, a viewer who owned a large high definition television would be able to view these images as equally large high definition images. Advertisers have already recognized the potential impact of using high quality photographic images in their current brochures, catalogues, and print ads, such as those used in glossy magazines. Thus advertisers will likely find the ability to deliver even larger high quality images a distinct marketing advantage over their competitors who do not use the current method.

Another advantage of the current invention is that marketers may use the method to deliver catalogues and other stepped-frame content via the internet, through streaming or other means, as a form of “push technology” or “push marketing.” Traditionally, internet users typically receive noncommercial video content such as news or entertainment by visiting a Website and clicking on a link to such content, thus “pulling” the content. Advertisers, however, often prefer to “push” marketing content, which they currently achieve by attaching it to the “pulled” noncommercial content, for example, where an advertiser attaches a video commercial to a news clip requested by the user. Thus advertisers can use the current invention to attach a piece of stepped-frame content such as a catalogue to the beginning of a piece of pulled” noncommercial content. This has the advantage of allowing the advertiser to deliver a catalogue or similar piece of stepped-frame content to viewers for a wide range of news and/or entertainment content by “pushing” such content to such users as opposed to relying on users visiting the advertiser's Website and requesting, or “pulling” such content.

Because the location and length of the stepped-frame content included within a video presentation may vary considerably, it will therefore become useful to “code” the content so that a user's video recording device (such as a PDVR, set-top box, or PC-based video viewer) can automatically detect, identify, and interpret the stepped-frame content. Coding of frames is well known and practiced by those having skill in the art of the invention. Coding takes only a small fraction of the data contained in a single frame of video and can be accomplished without noticeably affecting playback or viewing. A video recording device capable of automatically detecting coded video frames, identifying the type of content, and interpreting that content in terms of its relationships to other coded frames would enable a wide range of new and useful functionality.

Various methods for coding or “tagging” individual video frames to trigger various actions are known and practiced in the art. For example, such systems are typically used for verifying that advertisements have been properly broadcast. Tagging methods include encoding portions of the vertical blanking interval (VBI), as described in U.S. Pat. No. 4,805,020 issued to Greenberg, or in the audio portion of the signal, as described in U.S. Pat. No. 4,945,412 issued to Kramer. Other methods include those described in U.S. Pat. No. 6,947,598 to Yogeshwar, et al. titled “Methods and apparatus for generating, including and using information relating to archived audio/video data,” and U.S. Pat. No. 6,535,253 to Barton, et al. titled “Analog video tagging and encoding system”, which are incorporated herein in their entirety by reference. These tagging schemes include the ability to add indexing metadata to individual digitized video frames without interfering with the ability of the video recording device to read the originally created video file. During playback, high-speed electronics can provide automatic real-time detection, and copying or cutting of the tagged stepped-frame portions of the video stream. These tagged frames can then be archived in any convenient data storage medium, for example on a hard drive or in flash memory, for later retrieval. Buffering of the video stream by the video recording device can be used, if necessary, to eliminate time gaps during playback due to removal of the tagged video frames.

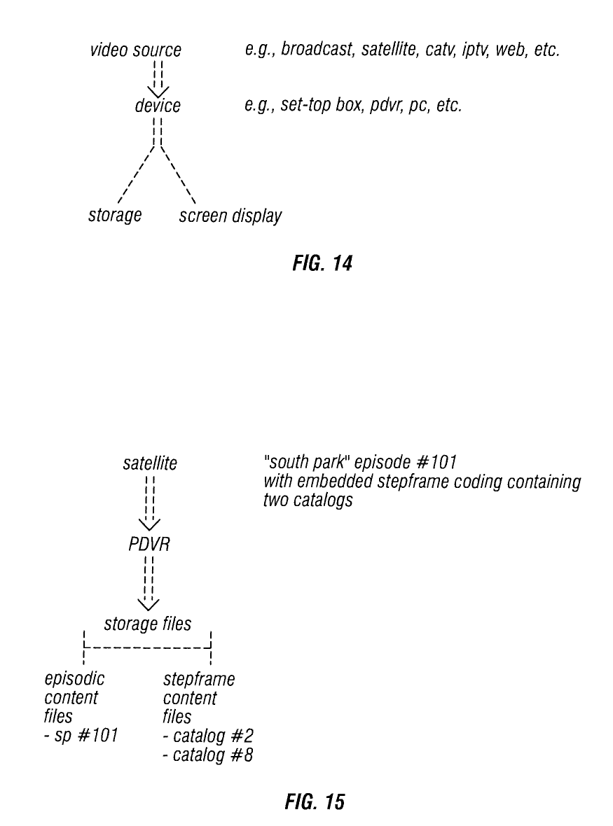

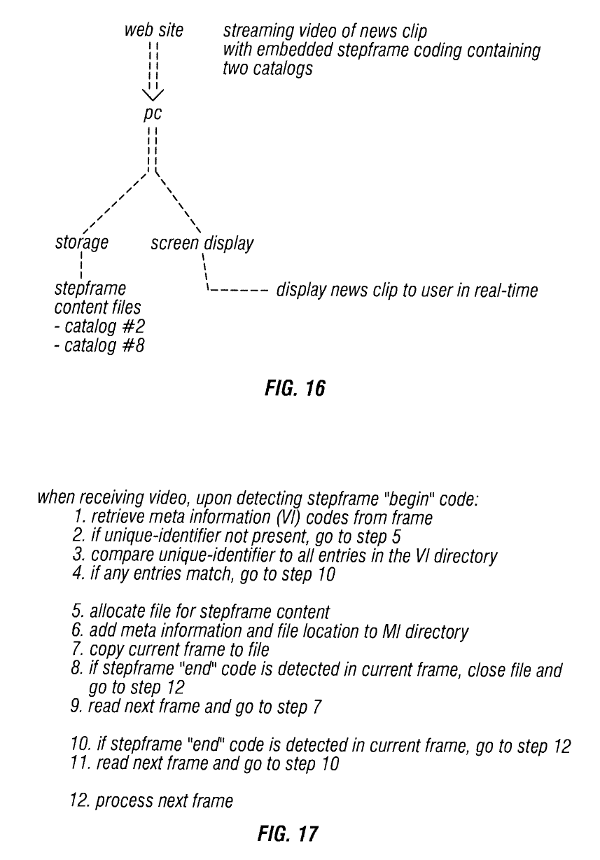

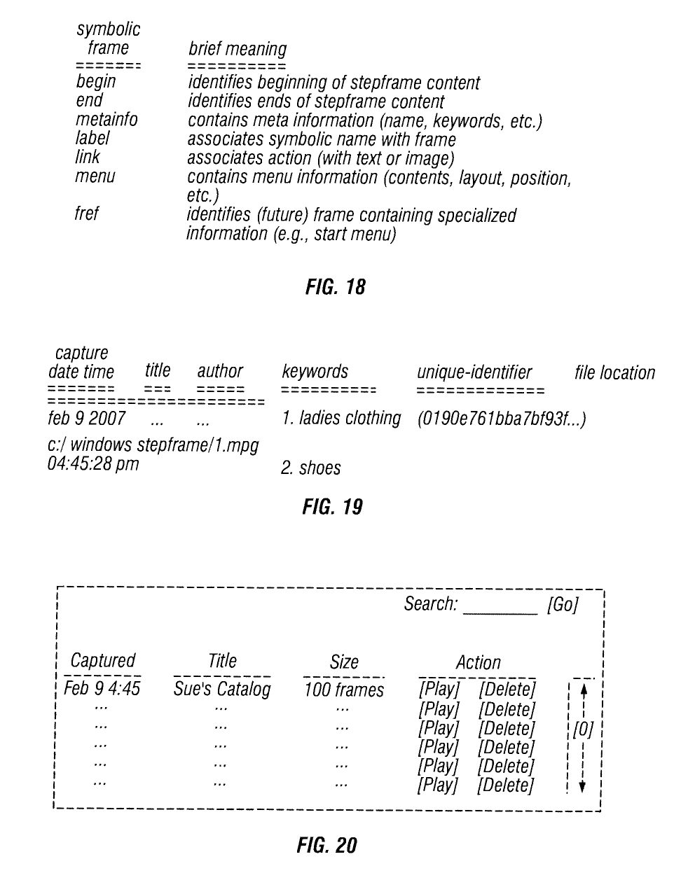

FIG. 14 depicts a flow diagram showing the basic components of the video coding scheme described above. Any of the many available types of video streams enters the video recording device, which then detects, identifies, and then stores the tagged video content while directing the untagged content to a viewing screen or display, preferably in quasi-real time. FIG. 15 presents a flow diagram for a particular exemplary embodiment wherein an episodic television show such as “South Park” is embedded with stepped-frame content comprising two catalogs, catalog #2 and catalog #8. The PDVR video recording device separates and stores the two catalogs in a separate memory location from the episodic content files, SP #101. In yet a third exemplary embodiment, FIG. 16 depicts a flow diagram in which streaming news video from a Website is directed to a PC having a video recording device capability that stores the two catalogs while presenting the streaming news video in real time. This represents a significant advantage over previous PC-based devices in which streaming video is typically permanently stored in its entirety or not at all. Accordingly, the separation of stepped-frame content from the “main” content is of vital improvement.

Many video recording devices already provide means for storing video content for subsequent playback, so that automatically detected stepped-frame content can be automatically saved, independent of any actions taken on the host video stream. This action may be taken regardless of whether or not the video recording device is “recording” the video stream in its entirety or not. Because of the relatively small memory required to save the stepped-frame data, even set-top boxes with no explicit ability to record episodic video can easily provide the small amount of memory needed for storing the tagged content using, for example, flash memory or other convenient media types. The video recording device may record stepped-frame data automatically, or may operate according to user input preferences such as “never”, “always”, or “ask”.

Many other functions become available for video recording devices capable of detecting stepped-frame content. For example, when implemented on a PC or other computer system, a video viewing program may be configured to store the stepped-frame content in a condition and format for use by other applications such as media center software. This functionality would allow program developers to make the stepped-frame content available to applications that are not “stepped-frame knowledgeable”.

In addition to providing coding that detects the stepped-frame content, coding that identifies the stepped-frame content is also useful. Metadata, such as name, author, keywords, unique-identifier, etc., may also be embedded within the stepped-frame video content. Embedding metadata allows a video recording device to make more intelligent decisions. For example, if the stepped-frame content contains a unique-identifier, and if, later on, new stepped-frame content is detected with the same unique-identifier, the video recorder device need not capture it a second time. FIG. 17 presents an exemplary algorithm for detecting and identifying coded stepped-frame video frames containing metadata information in addition to unique identifier and “end” codes. FIG. 19 depicts an exemplary metadata information directory showing certain exemplary attributes.

In another example of unique functionality that is enabled by the present invention, the viewer may indicate that stepped-frame content conforming to certain user selected search criteria, such as keywords, be automatically captured. This functionality would allow a viewer interested in “luxury cars” to specify this as a keyword to the video recording device, which in turn would automatically capture any stepped-frame content encountered having that keyword.

The video recording device may also provide the viewer with means to exercise choices and preferences. In one exemplary embodiment, the video recording device may provide a “selection window” to the viewer (available via pull-down window or some other user-interface artifact) allowing the viewer to review all captured stepped-frame content. FIG. 20 depicts an exemplary selection window that would appear on the video display and which provides the viewer with convenient means to make selections regarding disposition of the stepped-frame content according to their personal preferences. The review process allows the viewer to order or filter the content based on different criteria, such as date and time of capture, name, keywords, and so on. These interactive features allow the viewer to easily identify the desired stepped-frame content, and to select it for viewing, deletion, and so forth.

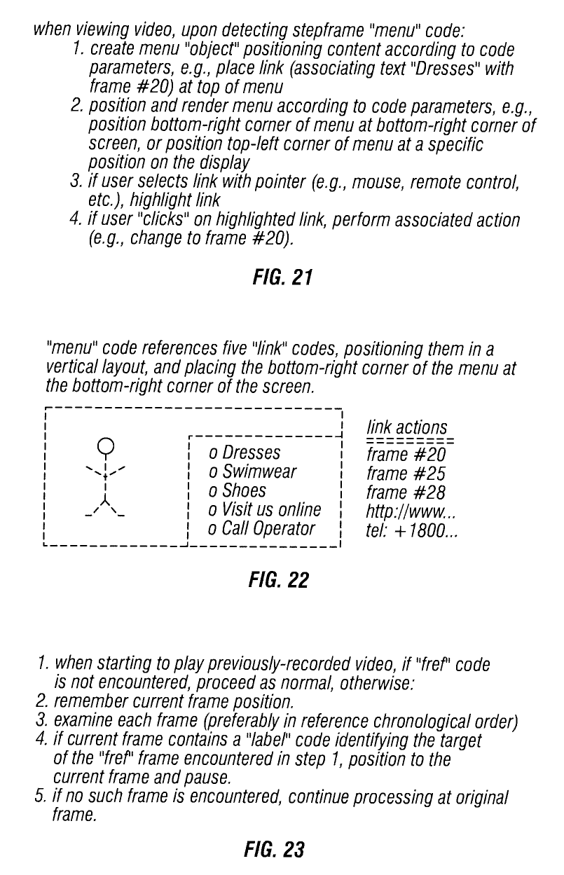

In addition to providing coding that detects and identifies the stepped-frame content, coding that interprets the stepped-frame content is also useful. These embedded codes are used for purposes such as providing links between frames (“internal links”), or links from a frame to a resource outside the stepped-frame content (“external links”). At its most basic, an internal link references another frame in the stepped-frame content. This provides functionality necessary to implement a “table of contents” or similar capability to allow a user to “jump” to a specific page, either by clicking on a link in a menu, or entering a frame number into a form, and so on. Note that internal links contain not only a pointer (e.g., “go to frame #7”), but also indicate whether the viewer should freeze at the frame or start playing. This dual “pointer” and “mode” ability allows internal links to support a wide-range of applications for the viewer. FIG. 21 presents an exemplary interpretive algorithm that demonstrates how codes embedded within the stepped-frame frames can be used to create relationships in links that provide enhance functionality.

There are several ways in which external links may also prove useful. For example, if a link to an Internet Uniform Resource Locator (“URL”) is present, then an Internet-connected video recording device can allow the viewer to reference the link and open up a Web browser to that page. Similarly, if a link references a telephone number, then a video recording device connected to the telephone network can dial that number to connect to a recorded message, consumer service representative, and so forth. Similarly, if a link references a printer, then a video recording device connected to a printer (either directly or through a data network), can, at the consumer's request, print the indicated frame or frames.

In many cases, links will offer choices to the viewer and, therefore, must be displayed. Thus, links are associated with menu coding that indicates the layout and positioning of a menu within the frame associated with the menu. This functionality is not unlike the menu capability found with DVD's and other kinds of physical storage media. However, it differs significantly in implementation. FIG. 22 depicts an exemplary viewer menu comprising an image and including links to related subjects, and showing their corresponding link actions.

For example, the frame associated with a “table of contents” might contain a still image of a background, along with menu coding and associated internal link coding for each category contained within the stepped-frame content (e.g., “lingerie”, “socks”, “scarves”). The viewer's video recorder device is responsible for interpreting the menu coding to render the appropriate menu to the view for a given frame. In another embodiment, internal link references or pop-up menus may be used to allow a viewer to use a remote control or keyboard or PC mouse to jump to a particular page, identified by a page number, or the beginning of a particular section of the stepped-frame content, such as the “swimwear” section of a clothing catalog, identified by a keyword, page number, or other identifier; e.g., by associating an image with an action using the “link” code.

Interpretive coding of frames need not necessarily appear at the chronological beginning of the stepped-frame content. In the case of live broadcasts, for example, it may be more feasible to encode this information into the final frames of the broadcast. Accordingly, in addition to allowing link references, there are also anchor codes that associate with a frame a symbolic identity. These anchors can be viewed as being analogous to “chapter stops” or “page numbers” in that they do not “point to something else” but, rather, “something else points” to them.

Codes used for detection, identification, and interpretation of video frames are not limited to stepped-frame content. In fact, the principles described herein for utilizing frame coding can be applied to any video content, regardless of whether it is intended for viewing in stepped-frame mode. That is, any content, such as a movie, news broadcast, or episodic show, and whether intended for delivery to a PDVR, PC, Cell Phone, or other device with recording capabilities, can contain the three types of coding described above, and for which these devices may be adapted for detecting and processing such codes. Additional types of codes may be used for other purposes applicable to real-time viewing; for example, for nesting (e.g., to identify commercial breaks). Even live content broadcasts can potentially contain coded frames; e.g., a special code at the beginning of the program can direct the video recording device to look at the end of the content for a “start menu” that makes reference to earlier codes in the video thereby enabling the device to organize the earlier content. FIG. 23 presents an exemplary algorithm that utilizes future reference frame or “fref” code that identifies a subsequent or “future” frame to look for that contains specialized information such as a start menu, etc. As with stepped-frame content, parts of the coded video content may be stored separately. For example, if codes are used to identify commercial breaks, that content may be stored separately from the “main” content.

This functionality is applicable to any type of content coded within the video and offers a much richer experience to the view. For example, currently when a movie is recorded from a video broadcast using a PDVR, chapter stops or menus are not included in the broadcast. However, if the interpretive coding described above were included in the video stream, this functionality would then become available to the video recording device, providing options previously only available with DVD and similar types of media. Similarly, when a movie is downloaded to a PC there are also no chapter stops or menus but, once again, the interpretive coding described above could be included to make this functionality available to the user. Accordingly, this present invention is not limited to stepped-frame content, but applies to all forms of video content in any format including, but not limited to, NTSC, SECAM, PAL, HDTV, IPTV, etc.

In a preferred embodiment, the systems and methods described above may be implemented in the context of an MPEG-2 transport stream. Following is a description of an exemplary architecture for the generation, delivery, reception and rendering of stepped-frame content in the context of an MPEG-2 transport stream. It will be appreciated, however, that embodiments of the invention are not so limited.

MPEG-2 is a set of standards for the generic coding of moving pictures and associated audio information, established by the Moving Pictures Experts Group and adopted by ISO/IEC. The MPEG-2 standards define how to format the various component parts of a multimedia program, which may consist of: MPEG-2 compressed video, compressed audio, control data and/or user data). It also defines how these components are combined into a single synchronous transmission bit stream. The process of combining the steams is known as multiplexing. Some aspects of the MPEG-2 standards are described in detail below to aid in the understanding of various embodiments of the present invention. Other aspects of the MPEG-2 standards are well-known by those of ordinary skill in the art, and are not described in detail herein.

The MPEG-2 standards allow two forms of multiplexing; the MPEG Program Stream and the MPEG Transport Stream.

An MPEG-2 Program Stream is used for pre-recorded digital storage media (e.g., DVDs) and in high reliability networks where transmission errors are rare (e.g., bit error rates less than 10⁻¹⁰). In an MPEG-2 Program Stream, the individual video and audio streams of a single program are synchronous (i.e., referenced to the same time base) and are easily and simply decoded at the receiver. The MPEG-2 Program Stream is not appropriate for long-haul digital video delivery such as that associated with digital video broadcasts (DVB) over satellite and cable television systems, for example, which are subject to transmission errors.

An MPEG-2 Transport Stream (TS) is a multi-channel transmission where the various program sources are not necessarily synchronous. The source of the timing for each elementary stream (i.e., each video, audio, data and control stream) is the MPEG encoder at the transmitter, and the corresponding MPEG decoder in the receiver must synchronize with the encoder. Therefore, each elementary stream must contain additional synchronizing information to lock the encoder and decoder clocks together for that stream.

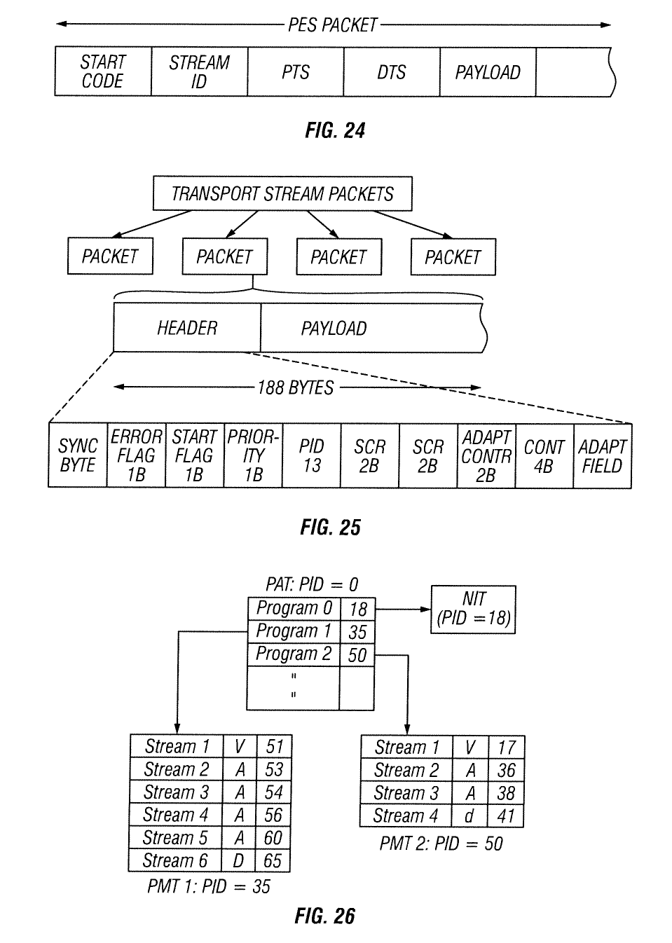

After encoding, an elementary video stream carrying programming is a continuous bitstream representing I-frames (intracoded frames), P-frames (uni-directionally predicted frames) and B-frames (bi-directionally predicted frames) which are not necessarily in the correct order. For example, B-frames, which are bi-directionally interpolated from preceding and succeeding P or I frames, may be transmitted after their corresponding P-frames or I-frames. Additionally, each frame may take a variable length of time to transmit, depending on the relative type and complexity of the frame. Storage and transmission systems prefer discrete blocks of data, so each elementary stream is packetized to form a packetized elementary stream (PES). Audio elementary streams are also packetized. FIG. 24 illustrates a PES packet. The packet begins with a header containing a unique packet start code that identifies the type of data stream (e.g., audio, video, data, etc.) and a stream ID that identifies a particular program stream. Optionally, the packet header may also contain one or more time stamps that are used for synchronizing the video decoder to real time and for obtaining synchronization with the audio stream.

There are two types of time stamp, PTS and DTS, abbreviations for presentation time stamp and decode time stamp, respectively. A presentation time stamp determines when the associated picture should be displayed on the screen and the decode time stamp determines when it should be decoded (in bi-directional coding, these two times can be different). Audio packets have only presentation time stamps. In practice, the time between frames is constant, so there is a certain amount of redundancy in the time stamps. Time stamps can be up to 100 milliseconds apart in a transport stream. As each frame type (I, P or B) is flagged in the bitstream, the decoder can infer the PTS/DTS for every frame from the ones actually transmitted.

The MPEG-2 transport stream is intended to be a multiplex of many TV programs with their associated audio and data channels, although a single program transport stream (SPTS) is possible. The transport stream is based upon packets of constant size, derived from PES packets, so that multiplexing, adding error-correction codes and interleaving in a higher layer is possible. As illustrated in FIG. 25, the transport stream packets are 188 bytes long. Transport stream packets always begin with a header. The remainder of the packet carries data known as the payload. For efficiency, the normal header is relatively small, but for special purposes, the header may be extended, in which case the payload is reduced to maintain a constant packet length.

The header begins with a synchronization byte which is a unique pattern (0x47) detected by a demultiplexer. A transport stream may contain many different elementary streams and those are each identified by a unique 13-bit Packet Identification Code (PID) that that is included in the header. A demultiplexer seeking a particular elementary stream simply checks the PID of every packet and accepts those that match, rejecting the rest. In a multiplexed transport stream, there may be many packets from other programs in between packets of a given PID. To help the demultiplexer, each packet header includes a continuity count; a four bit value that increments at each new packet having a given PID.

The complete header includes the following fields: 1) a transport error flag; 2) a start of a payload flag; 3) a transport priority flag; 4) the 13 bit Packet Identifier (PID); 5) two scrambling control bits used by conditional access procedures to encrypted the payload of some TS packets; 6) two adaptation field control bits which may take four values (01—no adaptation field, payload only, 10—adaptation field only, no payload, 11—adaptation field followed by payload, 00—RESERVED for future use); 7) the 4-bit Continuity Counter (4 bits).

This approach allows statistical multiplexing, because it doesn't matter how many or how few packets have a given PID; the demultiplexer will still identify them. Transmission systems prefer to operate at a constant bit rate (CBR), which eases the management of transmission and reception buffers. However, statistical multiplexers have the problem that it is virtually impossible to make the sum of the input bit rates constant because each elementary stream has a variable bit rate (VBR) that is uncorrelated with the other elementary streams. Instead, the multiplexer is designed to accommodate an average bit rate that is slightly less than the capacity of the transmission channel, and the instantaneous bit rate is kept constant by adding null packets. Null packets have a unique PID (typically 0x1FFF) that the demultiplexer at the receiver is programmed to ignore. At the transmitter, the null packets may be added to individual elementary streams to render each stream as a CBR stream. Alternatively, null packets may be added to the aggregate of the elementary streams to render the overall transport stream as a CBR stream.

Embodiments of the present invention may advantageously replace some or all of the null packets of a conventional transport stream with packets carrying metadata associated with the stepped frame video content described above. The metadata packets may be assigned a unique PID that defines a metadata elementary stream. The metadata may include, for example, product information such as price, color, options, ordering and contact information or instructions for interactive purchases via a cable uplink.

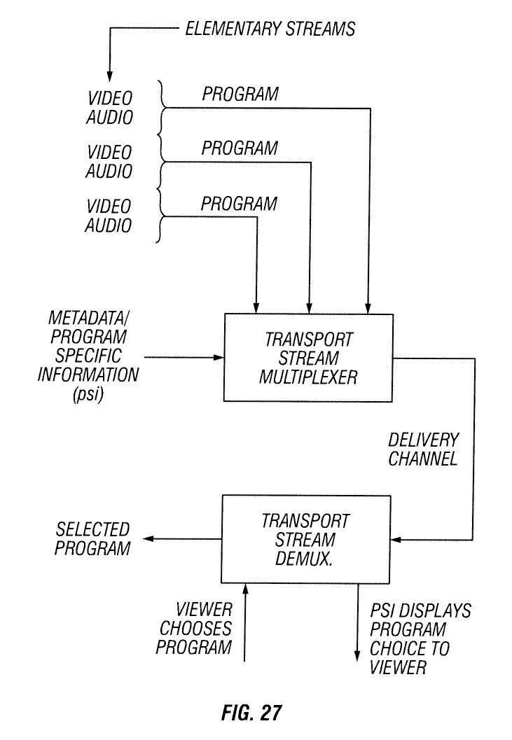

In a transport stream, each elementary stream has a different PID. In order to sort out the program material, a demultiplexer has to be told what the PIDs are and what audio, video and data streams belong together before it can operate. This function is provided by Program Specific Information (PSI) embedded in the transport stream. FIG. 26 illustrates the organization of the PSI. When a demultiplexer powers up, it knows nothing about the incoming transport stream, so it is programmed to look for packets with a PID equal to zero (0x0000). This PID is reserved for the Program Association Table (PAT), which is transmitted at regular intervals and contains a list of all the programs in the transport stream. In the PAT, each program in the transport stream is associated with a special PID corresponding to packets containing data for a Program Map Table (PMT) for that program. For example, in FIG. 27, Program 1 in the PAT is associated with PID 35. The demultiplexer can then select packets with PID=35 to assemble the PMT for Program 1, PMT-1. PMT-1 includes all of the streams (video, audio and data) associated with Program 1 and their respective PIDs. Similarly, Program 2 in the PAT is associated with PID 50. The demultiplexer can then select packets with PID=50 to assemble the PMT for Program 2, PMT-2. Consequently, when the viewer selects a particular program, the demultiplexer looks up the program number in the PAT, finds the correct PMT, and reads the audio, video and data PIDs for the selected program. It then selects the Elementary Streams having those PIDS and routes them to the appropriate decoders.

Program 0 in the PAT is reserved for the PID of a Network Information Table (NIT). The NIT contains information about what other transport streams may be available. Using the NIT, a Set Top Box (STB) could automatically switch between different transport streams. This same data architecture may be used to generate on-screen program guides and schedules that allow the viewer to make the program selections for viewing and recording.

The MPEG-2 Transport Stream is so designated to signify that it is the input to the Transport Layer in the ISO Open System Interconnection (OSI) seven-layer network reference model. It is not, in itself, a transport layer protocol and no mechanism is provided to ensure the reliable delivery of the transported data. MPEG-2 relies on underlying layers for such services. MPEG-2 transport requires the underlying layer to identify the transport packets, and to indicate in the transport packet header, when a transport packet has been erroneously transmitted.

When the MPEG-TS is used over a lower layer network protocol, the lower layer must identify the start of each transport packet, and indicate in the transport packet header when a transport packet has been erroneously received. The MPEG TS packet size also corresponds to eight Asynchronous Transfer Mode (ATM) cells, assuming an 8 byte overhead (associated with the ATM Adaptation Layer (AAL)).

A TS may correspond to a single TV program or multimedia stream (e.g. with two video PESs and an audio PESs). This type of TS is normally called a Single Program Transport Stream (SPTS).

An SPTS contains all the information requires to reproduce the encoded TV channel or multimedia stream. It may contain only audio and video PESs, but in practice there will be other types of PESs as well. Each PES shares a common time base. Although some equipment outputs and uses SPTS, this is not the normal form transmitted over a digital video broadcast (DVB) link such as that provider by cable television providers (e.g., Cox, Comcast, etc.). In most cases one or more SPTS streams are combined to form a Multiple Program Transport Stream (MPTS). This larger aggregate also contains all the Program Specific Information (PSI)) described above, which is required to co-ordinate the DVB system, and any other data which is to be sent.

The foregoing description of the MPEG2 transport stream (MPEG2TS) is provided to establish a context for the following description of a preferred embodiment of a system and method for the generation and delivery of stepped-frame content over an MPEG-2 transport stream. In one embodiment, the system and method includes a stepped frame content authoring tool, an MPEG conversion tool, a splicing tool, a set top box (STB) plug-in for stepped-frame content parsing, a stepped-frame content renderer and a stepped-frame content library management tool as described below.

### System Overview

In one embodiment, a system for generating stepped-frame content includes a stepped-frame content publisher (SCP), also referred to herein as a stepped-frame content authoring tool, having the following capabilities:
Selection of images of various formats (including, but not limited to JPEG, BMP and GIF images) and sizes (e.g., full frame, ½ frame and ¼ frame).
Specifying commercial and business metadata surrounding the SFC, including
   Product Type for classification and sub classification
   Product Specific Information (e.g. product name cost, color and other details based on the classification).
   Display/rendering information (e.g. screen layout and image size)
Merging the SFC into the broadcasting stream (splicing)

In one embodiment, a system for managing and viewing SFC includes a set top box (STB) application and plug-in configured to allow a viewer to:
view television programs with minimal disruption by the SFC.
select SFC for viewing with a STB remote control.
browse through various genres and categories of SFC in a convenient way.
obtain more information about a particular product/service on demand as well as complete a commercial transaction on demand whenever internet connectivity to the STB is available.

### System Architecture

In one embodiment, an end-to-end stepped-frame system architecture may include the following functional modules:
1. A utility to prepare images and ad metadata into a standard playable media format.
2. A tool to convert the images and metadata into MPEG with the images as the media and the metadata and private data for the media.
3. A tool to insert (splice) the stepped-frame MPEG content into the broadcast stream as an MPEG2 Transport Stream with markers at the beginning and end of the stepped-frame content.
4. A plug-in at the viewer's Set Top Box to capture the stepped-frame content out of the broadcast stream and to store it on an internal hard disk.
5. An application in the Set Top Box to present the stepped-frame content for easy user operations, navigation and selections.

### Stepped-Frame Content Authoring Tool

The stepped-frame content authoring tool allows a stepped-frame content author to choose ads and corresponding metadata to be included in the SFC and to compose the SFC. The metadata of each Ad may contain the following information:
1. Display attributes and viewing experience of the Ad: Typical display information may include,
   a. Location of the Images
   b. Layout of the content
   c. Timing of audio visuals
2. Commercial information of the Ad: Typical commercial information may include,
   a. Product classification and sub-classification
   b. Product details based on classification. (e.g. Model/Make, Pricing details etc.)

Apart from the above information, package level metadata may also be prepared. This metadata may be used to support images of different sizes. The MPEG format does not permit different frames to have different sizes. Therefore, the images have to be adjusted (similar to N-up of printing) so that the entire frame is utilized and the viewer does not see blank spaces while the stepped-frame content is displayed on the TV screen. At the STB, these adjusted images are cut back into their original shape and size. The package level metadata contains the necessary information. The following illustrates an exemplary XML file defining the structure of this metadata.

<XML>
<sfc-package id=“12ada23441”>

<!-Full Image -->
<frame id=“1” format=“1”>

<image name=“full-img.jpg”/>

</frame>

<!-- 2 half images horizontal -->

<frame id=“2” format=“21”>

<image name=“half1.jpg”/>
<image name=“half2.jpg”/>

</frame>

<!-- 2 half images vertical -->

<frame id=“2” format=“22”>

<image name=“half1.jpg”/>
<image name=“half2.jpg”/>

</frame>

<!- 3 Quarter images and 4^{th} image is empty -->

<frame id=“2” format=“43”>

<image name=“quarter1.jpg”/>
<image name=“quarter2.jpg”/>
<image name=“quarter3.jpg”/>

</frame>

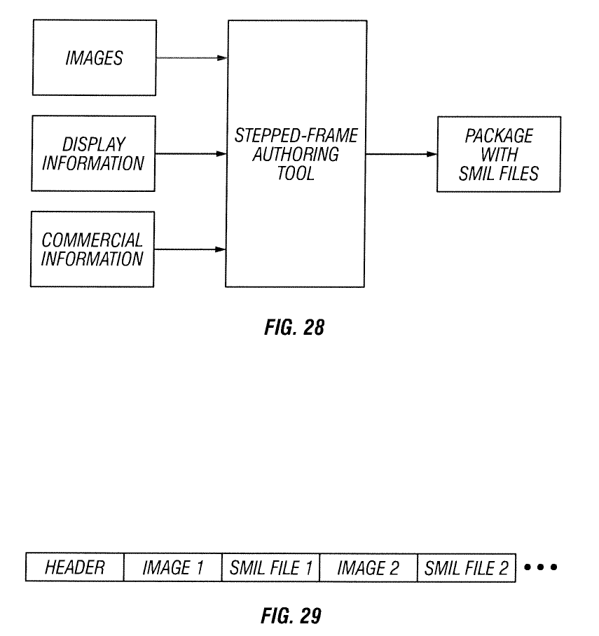

As illustrated in FIG. 28, the stepped-frame authoring tool converts the Ad images and the metadata into a package containing a SMIL file. (see Appendix A for a description of the SMIL language and its usage). FIG. 29 illustrates an exemplary data structure, including a header, one or more image files and a SMIL file corresponding to each image file. An exemplary SMIL file is listed below:

<SMIL>

<HEAD>

<LAYOUT type=“text/smil-basic-layout”>

<REGION top=“0” left=“0” width=“592”
height=“439”
z-index=“20” id=“preview region”/>

<REGION ... />

</LAYOUT>
<TRANSITION type=“barWipe” id=“Filter1” dur=“5” />

</HEAD>
<BODY>

<PAR id=“root” dur=“5s” begin=“0s”>

<IMG src=“Image1.jpg” duration=“3s” />
<IMG ... />

</PAR>

</BODY>

</SMIL>

In one embodiment, the stepped-frame authoring tool may be based on LiSee2, which is a cross platform SMIL 2.0 authoring tool. LimSee2 has a multi-view solution that renders the structure of the SMIL document at different levels during the authoring process: timing and synchronization, spatial layout, XML tree etc. The different views are synchronized (a modification in one view is immediately rendered in all the other views) and provide functionality that allows a user to manipulate and fine-tune a SMIL document without requiring a full knowledge of the language.

### MPEG Conversion Tool

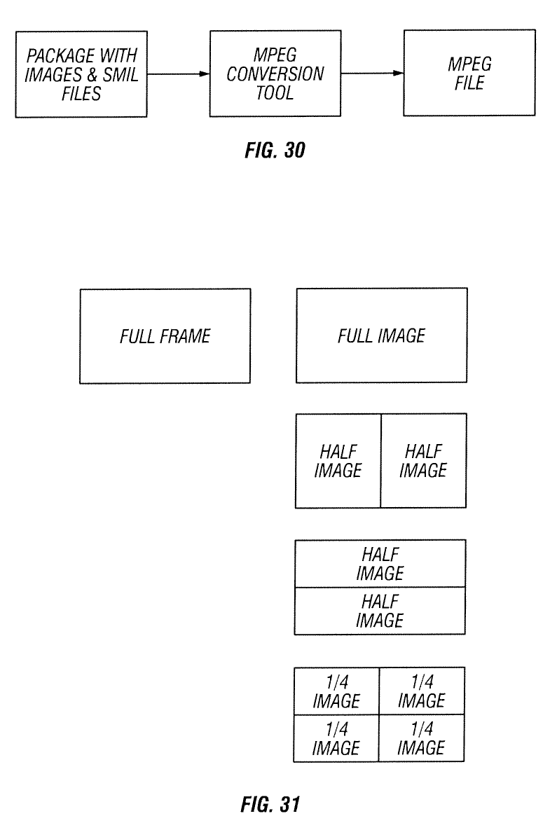

As illustrated in FIG. 30, the MPEG conversion tool converts the SMIL files package into an MPEG-2 file. This MPEG file primarily contains the ad media (images). The SMIL files containing metadata and package metadata are attached to the MPEG media as private data.

In one embodiment, the MPEG is converted in compliance with NTSC format (30 frames/second). Thus, it allows 30 frames (where, as illustrated in FIG. 31, each frame can contain up to 4 images, each of ¼ size.) to be encoded per second. If we consider a duration of 5 seconds for each MPEG file, them stepped-frame content for 150 Ads (30*5) or more can be enclosed.

The salient features of the generated MPEG file are:

it does not contain audio.

each frame consists of 1 or more images.

as each image is a distinctive image, each frame is an Intra-coded frame (I-Frame).

It will have constant bit rate of 5 Mbps.

All the images need not be the same size as the MPEG Frame. So, the images may have to be joined, based on their size, to fit the frame size as illustrated in FIG. 30. The MPEG Conversion tool joins the images to fit the frame and prepares the metadata about how to divide the frame to get the actual images. If images are not available to fill the complete frame, fillers may be used. (e.g., if there are 3 images of ¼ size, then the 4^{th} quadrant may be filled with a filler. This filler could be a repeat of the last image itself.

### Splicing Tool

For broadcasting, the MPEG file has to be sent using the MPEG2-Transport Stream (MPEG2TS) as described above. This process is known as multiplexing (or muxing). While the MPEG standard specifies how media has to be decoded, the MPEG2TS protocol specifies how to transmit various media elements (audio, video and data) efficiently over the network. All television programs in MPEG format are converted to MPEG2TS before broadcasting. The process of inserting an MPEG file with stepped-frame content into the actual broadcast stream is called splicing. A splicing tool allows a broadcast administrator to choose the following options:
the stepped-frame content to be spliced
the broadcast channel in which the stepped-frame content has to be spliced
the time position of the splicing in the broadcast stream
   The following content may be spliced into the broadcast stream.
MPEG files containing images
SMIL files containing layout and display information for the images
XML files containing commercial and product information
Package level metadata primarily containing information about how the MPEG frames have to be broken down to individual images.

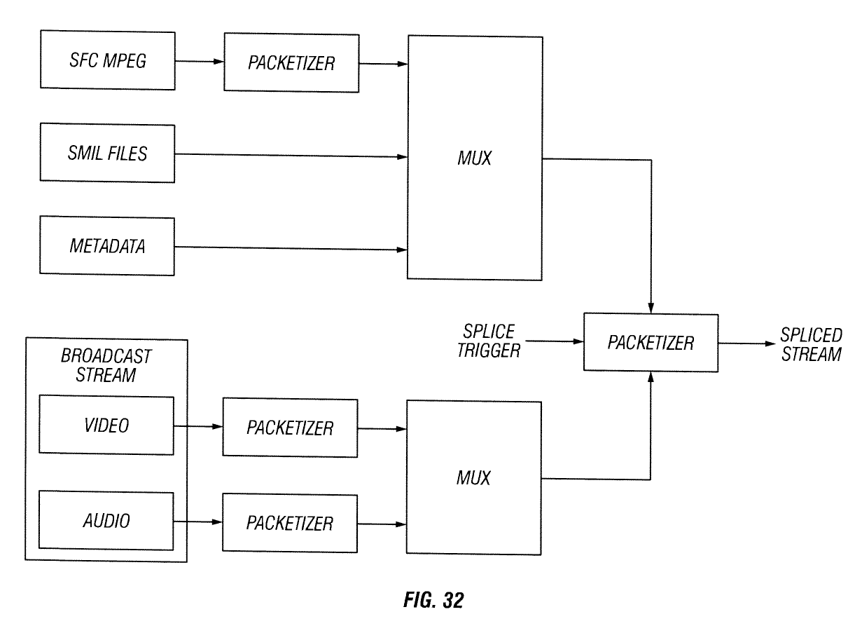

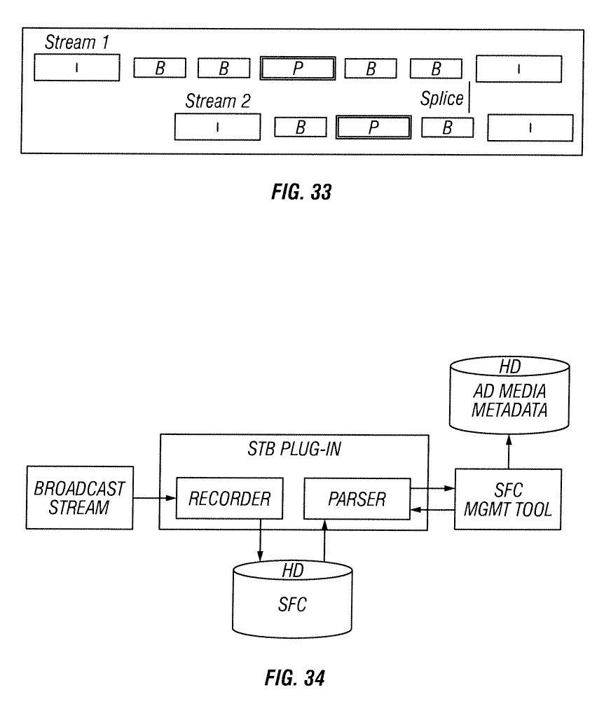

As described above, the MPEG Transport stream divides the MPEG content (video, audio and data) into packets each of 184 bytes. The stream of packets is called PES (Packetized elementary stream). A PES packet header contains a packet identifier (PID). A Program Association Table (PAT), which is transmitted at regular intervals, contains the mapping of PIDs and the payload of the packet to identify the type of content (video, audio or data). The splicing process is illustrated in FIG. 32. Splicing must be timed to ensure that the broadcast stream is not corrupted. Therefore, the splicing can happen only before start of I-Frame as illustrated in FIG. 33.

### Stepped-Frame Set Top Box Plug-in

The broadcast stepped-frame content needs to be captured by a user's set top box and stored there on its hard disk so that the ads and related information can be presented to the viewer when required.

As illustrated in FIG. 34, the STB plug-in watches the broadcast stream for stepped-frame content. It can identify the stepped-frame content based on markers at the beginning and end of the stepped-frame content. As soon as the plug-in recognizes a stepped-frame content beginning marker, it records the content until it encounters an ending marker. Once the entire stepped-frame content has been recorded, it separates the ad media and the SMIL files which are stored as private data.

When the beginning marker is identified in the stream, the plug-in reads the PID of each TS packet. Based on the PID, the plug-in identifies the type of content (ad Media and type of metadata). It then provides the stepped-frame content to the stepped-frame renderer. This tool stores the stepped-frame content as explained below.

### Stepped-Frame Content Renderer

In one embodiment, stepped-frame content is organized by classification (e.g., product type), so that a user can:

browse through ads

identify and select the ad or ads the viewer wants to see

obtain additional details (e.g., metadata content) of the ad

locate ads related to selected ads

file and organize ads according to the viewer's own preferences

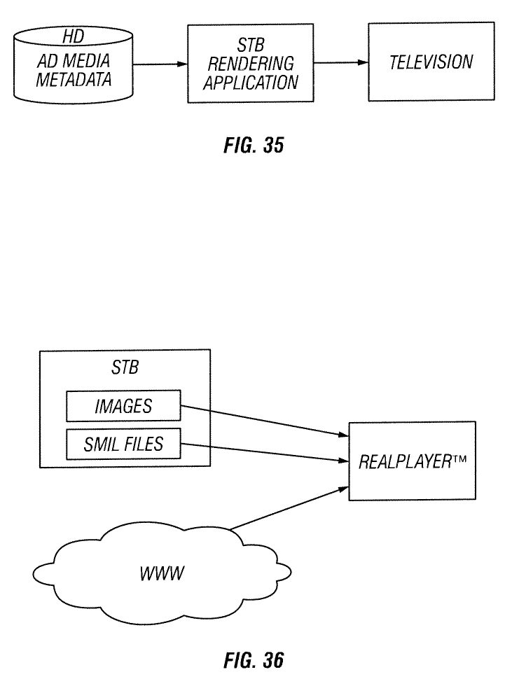

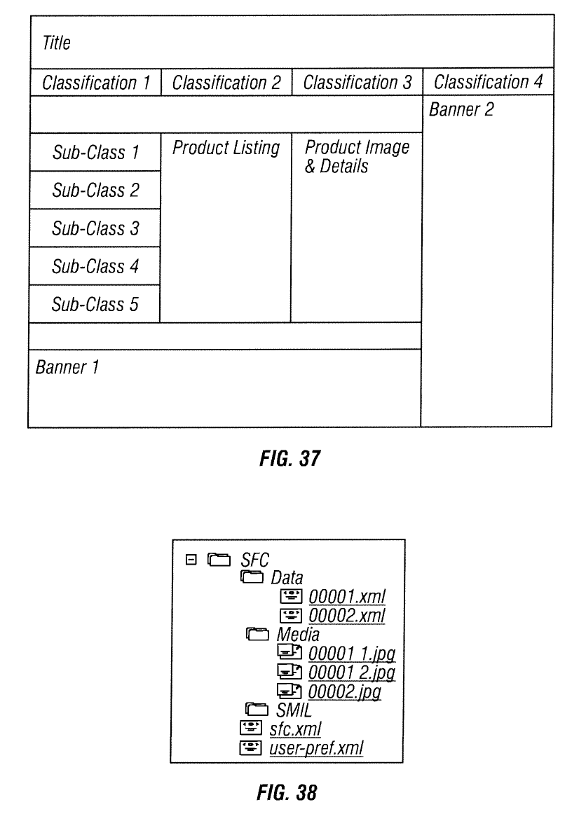

The SFC renderer presents the Ads to achieve the above objectives as illustrated in FIG. 35. In one embodiment, as illustrated in FIG. 36, a commercial multimedia player, such as RealPlayer™ available from Real Networks, Inc., may be used as a rendering application, although the invention is not so limited. Advantages of a commercial multimedia player, such as RealPlayer™, are compatibility with SMIL files, support for a wide range of audio and video media formats, compatibility with embedded references to other media on the Web, and easy display of text compared with other SMIL players. In one embodiment, the stepped-frame content renderer may provide a screen layout as illustrated in FIG. 37.

### Stepped-Frame Content Library Management Tool

The stepped-frame content store in the STB hard disk has to be managed regularly for the following reasons.
The amount of stepped-frame content stored in an STB is limited by the capacity of the hard disk of the STB.
Some stepped-frame content will become invalid after certain period. (e.g. ads related to Christmas gifts are applicable only up to Christmas)
Some existing stepped-frame content will be updated. (e.g. pPricing changes, discount offers to already stored stepped-frame content).
The viewer may be interested in only some classified ads. In that case, only stepped-frame content for the selected classification will be stored and presented.

FIG. 38 illustrates an exemplary folder structure for storing the stepped-frame content in one embodiment. The sfc.xml file contains information about how many stepped-frame contents are available and their identifiers. The file may be defined as illustrated by the XML file below:

<?xml version=“1.0” ?>
<sfcontents>

<sfc id=“000001” expiry-date=“2007/09/29”

related=“000003,000009”>

<smil-content>00001.smil</smil-content>
<data>000001.xml</data>
<layout>layout1</layout>

</sfc>
<sfc id=“000002” expiry-date=“2007/11/29”>

<smil-content>000002.smil</smil-content>
<data>000002.xml</data>
<layout>layout2</layout>

</sfc>

</sfcontents>

The user-pref.xml file contains user preferences for the Ads. The file may be defined as illustrated by the XML file below:

<?xml version=“1.0” ?>
<preferences>

<user-pref>

<name>User ABC</name>
<preference>Cars</preference>
<preference>Hotels</preference>

</user-pref>

<user-pref>

<name>User XYZ</name>
<preference>Books</preference>
<preference>Cloths</preference>

</user-pref>

</preferences>
</sfcontents>

The data folder contains commercial information about each stepped-frame content. The folder may be defined as illustrated by the XML file below:

<?xml version=“1.0”?>
<data>

<classification>Automobile</classification>
<subclassification>Cars</subclassification>
<make>Ford</make>
<model>Mustang</model>
<price unit=“USD”>19000</price>
<extrenal-link>

http://www.fordvehicles.com/cars/mustang/

</extrenal-link>

</data>

The SMIL folder contains the layout and rendering information. A sample SMIL fil is illustrated below:

<smil xmlns=“http://www.w3.org/2001/SMIL20/Language”>

<head>

<meta name=“title” content=“Ford Mustang” />
<meta name=“copyright” content=“Stepframe Inc.” />
<layout>

<root-layout width=“500” height=“400”

backgroundColor=“white” />

<region id=“title” width=“500” height=“50” left=“5”

top=“5” z-index =“1” />

<region id=“class” width=“500” height=“30” left=“5”

top=“60” z-index =“2” />

<region id=“subclass” width=“80” height=“250”
left=“5”

top=“62” z-index =“3” />

<region id=“prodlist” width=“80” height=“250”

left=“85” top=“62” z-index =“4” />

<region id=“prodinfo” width=“80” height=“250”

left=“165” top=“62” z-index =“5” />

</layout>

</head>
<body>

<par dur=“indefinite”>

<brush id=“titlebr” color=“#FFFFCC” region=“title”

fill=“hold” />

<textstream src=“text.rt” begin=“00:00.0”

region=“title” fill=“hold” />

<brush id=“classbr” color=“#FFCCFF” region=“class”

fill=“hold” />

<textstream src=“class.rt” begin=“00:00.0”

region=“class” fill=“hold” />

<brush id=“subclassbr” color=“#CCFFFF”

region=“subclass” fill=“hold” />

<textstream src=“subclass.rt” begin=“00:00.0”

region=“subclass” fill=“hold” />

<img src=“/media/00001.jpg” begin=“00:00.0”

transIn=“leftSlide” region=“prodinfo” fill=“hold” />

</par>

</body>

</smil>

### Other Applications

As noted above, stepped-frame content may be used to transmit images such as JPEG or other image formats, within an MPEG2 transport stream. However, applications of the present invention are not so limited. An MPEG compatible frame need not necessarily encode an image. Fundamentally, an MPEG frame, and in particular an MPEG I-frame is a collection of data. Therefore, the stepped-frame content may be used to transmit pure data at a data rate comparable to digital video broadcast rates. For example, stepped-frame content may be used to download books, telephone directories, encyclopedic references and the like.

In one embodiment, stepped-frame content may be embedded within an MPEG2 transport stream and may appear as a blur of rapid images between normal broadcast content to alert a viewer that stepped-frame content has been received. Alternatively, the stepped-frame content may include control metadata configured to communicate with a viewer's STB, to freeze frame normal programming for periods when the normal programming has low frame to frame change rates, in order to extract and store the stepped-frame content without the viwer's conscious perception.

In one embodiment, the STB application may be configured to record and report (e.g., via a conventional cable or satellite back-channel) to a stepped-frame content provider, viewing statistics. For example, a viewer who views a certain number or certain class of stepped-frame content may receive “stepped-frame credits,” whereby the viewer will not be exposed to standard in-line commercials during digital video broadcasts and will be able to view programs commercial free.

In one embodiment, the stepped-frame application resident in the viewer's STB may operate as a fulfillment agent. For example, if after viewing a selected stepped-frame content, the user desires to make a product purchase, the user may a standard backchannel (e.g., an on-demand program ordering channel) to order specific goods or services. The STB resident application may be configured to use the same backchannel (via Internet connectivity) to report the sale to the vendor and the cable service provider. The sales report may subsequently be used to generate “per impression” or sales revenue for any of the entities involved in the creation and delivery of the SFC.

Embodiments of the present invention include various operations, which are described herein. These operations may be performed by hardware components, software, firmware or a combination thereof. Certain embodiments of the present invention may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or any other type of medium suitable for storing electronic instructions.

Additionally, some embodiments of the present invention may be practiced in distributed computing environments where the machine-readable medium is stored on and/or executed by more than one computer system. In addition, the information transferred between computer systems may either be pulled or pushed across the communication medium connecting the computer systems such as in a remote diagnosis or monitoring system.

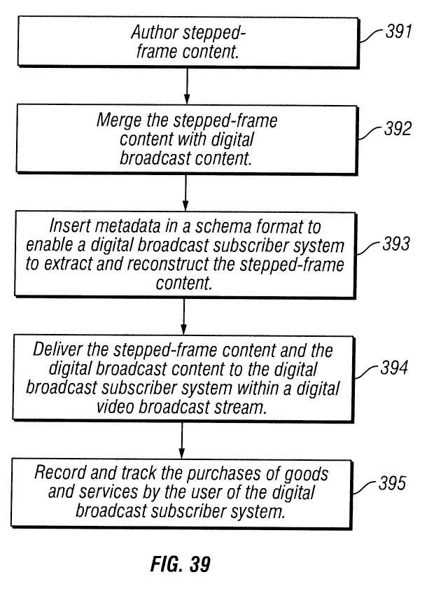

FIG. 39 is a flowchart illustrating a method in a system for delivering stepped-frame content via MPEG transport streams in one embodiment of the invention. At operation 391, stepped-frame content is authored in a SFC authoring system. At operation 392, the SFC is merged with digital broadcast content. At operation 393, metadata is inserted in the digital broadcast stream to enable a digital broadcast subscriber system to extract and reconstruct the SFC. At operation 394, the SFC and the digital broadcast content are delivered to the digital broadcast subscriber system within a digital video broadcast stream. And, at operation 395, purchases of goods and services by the user of the digital broadcast subscriber system are recorded and tracked.

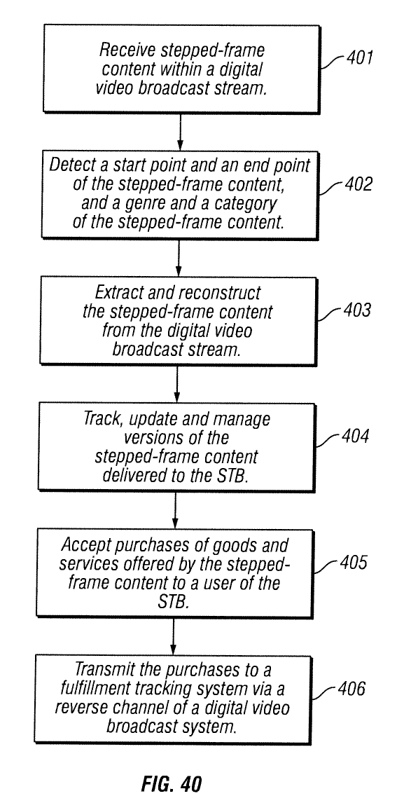

FIG. 40 is a flowchart illustrating a method in a set top box (STB) for receiving stepped-frame content via MPEG transport streams in one embodiment of the invention. At operation 401, the STB receives stepped-frame content (SFC) from a digital video broadcast stream. At operation 402, the STB detects the start point and end point of the stepped-frame content in the digital video stream and the genre and category of the SFC from metadata imbedded in the digital video stream. At operation 403, the STB extracts and reconstructs the SFC from the digital video stream. At operation 404, the STB tracks, updates and manages versions of the SFC delivered to the STB. At operation 405, the STB accepts purchases of goods and services offered by the SFC to the user of the STB. and, at operation 406, the STB transmits the purchases to a fulfillment tracking system via a reverse channel of the digital video broadcast system.

Although the operations of the method(s) herein are shown and described in a particular order, the order of the operations of each method may be altered so that certain operations may be performed in an inverse order or so that certain operation may be performed, at least in part, concurrently with other operations. In another embodiment of the present invention, instructions or sub-operations of distinct operations may be in an intermittent and/or alternating manner. Additionally, some operations may be repeated within an iteration of a particular method.

It should be understood that the foregoing description relates to exemplary embodiments of the invention and that modifications may be made without departing from the spirit and scope of the invention as set forth in the following claims. Accordingly, the inventions should not be limited based on the described embodiments. Rather, the scope of the inventions described herein should only be limited in light of the claims that follow when taken in conjunction with the above description and accompanying drawings.

What is claimed is:

1. A system to deliver stepped-frame content in a digital television distribution network, comprising:
an authoring system to author the stepped-frame content;
an integration system configured to merge the stepped-frame content with digital broadcast content, wherein the merged stepped-frame content and the digital broadcast content are configured to be delivered to a digital broadcast subscriber system within a digital video stream; and
an annotation system configured to insert metadata in a schema format to enable the digital broadcast subscriber system to extract and reconstruct the stepped-frame content from the digital video broadcast stream,
wherein the digital broadcast subscriber system comprises a stepped-frame content tracking system configured to track, update and manage versions of stepped-frame content delivered to the digital broadcast subscriber system.

2. The system of claim 1, wherein the stepped-frame content is configured to offer purchases of goods and services to a user of the digital video broadcast subscriber system.

3. The system of claim 2, further comprising a fulfillment tracking system to record the purchases of the goods and services by a user of the digital video broadcast subscriber system.

4. The system of claim 1, wherein a start point and an end point of the stepped-frame content and a genre and a category of the stepped-frame content are identified in the digital video broadcast stream, and wherein the digital video broadcast subscriber system is configured to detect the start point and the end point of the stepped-frame content and the genre and the category of the stepped-frame content.

5. The system of claim 1, wherein the authoring system is configured to import the stepped-frame content from a third party JPEG publishing program.

6. The system of claim 5, wherein the third party publishing program comprises one of Microsoft PowerPoint,® and Adobe PageMaker.®

7. The system of claim 1, wherein the digital television distribution network comprises one of an IP (Internet Protocol) network, a cable network and a satellite network.

8. An apparatus comprising a set top box (STB), wherein the STB is configured to:
receive stepped-frame content within a digital video broadcast stream;
extract and reconstruct the stepped-frame content from the digital video broadcast stream; and
track, update and manage versions of the stepped-frame content delivered to the STB.

9. The apparatus of claim 8, wherein the STB is further configured to detect a start point and an end point of the stepped-frame content, and a genre and a category of the stepped-frame content.

10. The apparatus of claim 9, wherein the STB is further configured to accept purchases of goods and services offered by the stepped-frame content to a user of the STB, and to transmit the purchases to a fulfillment tracking system via a reverse channel of a digital video broadcast system.

11. A method, comprising:
authoring stepped-frame content;
merging the stepped-frame content with digital broadcast content;
delivering the stepped-frame content and the digital broadcast content to a digital broadcast subscriber system within a digital video broadcast stream; and
inserting metadata in a schema format to enable the digital broadcast subscriber system to extract and reconstruct the stepped-frame content, wherein the digital broadcast subscriber system comprises a stepped-frame content tracking system configured to track, update and manage versions of stepped-frame content delivered to the digital broadcast subscriber system.

12. The method of claim 11, wherein the stepped-frame content is configured to offer purchases of goods and services to a user of the digital video broadcast subscriber system.

13. The method of claim 12, further comprising recording and tracking the purchases of goods and services by the user of the digital video broadcast subscriber system.

14. The method of claim 11, wherein a start point and an end point of the stepped-frame content and a genre and a category of the stepped-frame content are identified in the digital video broadcast stream, further comprising detecting the start point and the end point of the stepped-frame content and the genre and the category of the stepped-frame content.

15. A method in a set top box (STB), comprising:
receiving stepped-frame content within a digital video broadcast stream;
extracting and reconstructing the stepped-frame content from the digital video broadcast stream; and
tracking, updating and managing versions of the stepped-frame content delivered to the STB.

16. The method of claim 15, further comprising detecting a start point and an end point of the stepped-frame content, and a genre and a category of the stepped-frame content.

17. The method of claim 16, further comprising accepting purchases of goods and services offered by the stepped-frame content to a user of the STB, and transmitting the purchases to a fulfillment tracking system via a reverse channel of a digital video broadcast system.

18. A method, comprising:
receiving programming content and advertising content from a digital media server (server) at a digital media client (client);
storing the advertising content at the client and displaying the programming content, wherein the programming content is configured to notify a viewer of the stored advertising content;
displaying the advertising content in response to a request from the viewer; and
transmitting a confirmation from the client to the server comprising one or more of a client identifier, a programming content identifier, an advertising content identifier and a timestamp.

19. The method of claim 18, further comprising billing an advertiser for displaying the advertising content.

20. The method of claim 18, wherein the programming content is stored at the client before the programming content is displayed.

21. The method of claim 18, wherein the programming content is stored at the client while the programming content is displayed.

22. The method of claim 18, further comprising crediting the client for displaying the advertising content, wherein the client is enabled to display subsequent programming content without embedded advertising content.

23. The method of claim 18, wherein the programming content and the advertising content are displayed in near real time at the client when the programming content and the advertising content are received.

24. The method of claim 18, wherein the advertising content comprises a stepped-frame content, the stepped-frame content comprising image data and metadata.

25. The method of claim 24, wherein the programming content and the advertising content are embedded in an MPEG transport stream comprising a plurality of packetized elementary streams (PESs).

26. The method of claim 25, wherein the programming content comprises one or more of a video stream, an image data and video programming data and the metadata comprise an MPEG transport stream.

27. The method of claim 26, wherein the image data comprises one or more MPEG-2 group of pictures (GOP).

28. An article of manufacture, comprising a computer-readable medium including instructions thereon that, when read by a computer, cause the computer to perform operations, comprising:
authoring stepped-frame content;
merging the stepped-frame content with digital broadcast content;
delivering the stepped-frame content and the digital broadcast content to a digital broadcast subscriber system within a digital video broadcast stream; and
inserting metadata in a schema format to enable the digital broadcast subscriber system to extract and reconstruct the stepped-frame content, wherein the digital broadcast subscriber system comprises a stepped-frame content tracking system configured to track, update and manage versions of stepped-frame content delivered to the digital broadcast subscriber system.

29. The article of manufacture of claim 28, wherein the stepped-frame content is configured to offer purchases of goods and services to a user of the digital video broadcast subscriber system.

30. The article of manufacture of claim 29, wherein the operations further comprise recording and tracking the purchases of goods and services by the user of the digital video broadcast subscriber system.

31. The article of manufacture of claim 28, wherein a start point and an end point of the stepped-frame content and a genre and a category of the stepped-frame content are identified in the digital video broadcast stream, the operations further comprising detecting the start point and the end point of the stepped-frame content and the genre and the category of the stepped-frame content.

32. An article of manufacture, comprising a computer-readable medium including instructions thereon that, when read by a computer in a set top box (STB), cause the computer to perform operations, comprising:
receiving stepped-frame content within a digital video broadcast stream;
extracting and reconstructing the stepped-frame content from the digital video broadcast stream; and
tracking, updating and managing versions of the stepped-frame content delivered to the STB.

33. The article of manufacture of claim 32, the operations further comprising detecting a start point and an end point of the stepped-frame content, and a genre and a category of the stepped-frame content.

34. The article of manufacture of claim 33, the operations further comprising accepting purchases of goods and services offered by the stepped-frame content to a user of the STB, and transmitting the purchases to a fulfillment tracking system via a reverse channel of a digital video broadcast system.

35. An article of manufacture, comprising a computer-readable medium including instructions thereon that, when read by a computer, cause the computer to perform operations, comprising:
receiving programming content and advertising content from a digital media server (server) at a digital media client (client);
storing the advertising content at the client and displaying the programming content, wherein the programming content is configured to notify a viewer of the stored advertising content;
displaying the advertising content in response to a request from the viewer; and
transmitting a confirmation from the client to the server comprising one or more of a client identifier, a programming content identifier, an advertising content identifier and a timestamp.

36. The article of manufacture of claim 35, the operations further comprising billing an advertiser for displaying the advertising content.

37. The article of manufacture of claim 35, wherein the programming content is stored at the client before the programming content is displayed.

38. The article of manufacture of claim 35, wherein the programming content is stored at the client while the programming content is displayed.

39. The article of manufacture of claim 35, the operations further comprising crediting the client for displaying the advertising content, wherein the client is enabled to display subsequent programming content without embedded advertising content.

40. The article of manufacture of claim 35, wherein the programming content and the advertising content are displayed in near real time at the client when the programming content and the advertising content are received.

41. The article of manufacture of claim 35, wherein the advertising content comprises a stepped-frame content, the stepped-frame content comprising image data and metadata.

42. The article of manufacture of claim 41, wherein the programming content and the advertising content are embedded in an MPEG transport stream comprising a plurality of packetized elementary streams (PESs).

43. The article of manufacture of claim 42, wherein the programming content comprises one or more of a video stream, an image data and video programming data and the metadata comprise an MPEG transport stream.

44. The article of manufacture of claim 43, wherein the image data comprises one or more MPEG-2 group of pictures (GOP).
